(19) United States
(12) Patent Application Publication
(10) Pub. No.: US 2010/0055505 A1
(43) Pub. Date: Mar. 4, 2010

(54) MAGNETIC RECORDING MEDIUM, BINDER FOR MAGNETIC RECORDING MEDIUM, AND POLYURETHANE RESIN

(75) Inventors: Kazufumi Omura, Kanagawa (JP); Hirotaka Sato, Kanagawa (JP); Tadahiro Ooishi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/548,989

(22) Filed: Aug. 27, 2009

(30) Foreign Application Priority Data
Sep. 1, 2008 (JP) 2008-223021
Mar. 26, 2009 (JP) 2009-076982

(51) Int. Cl. G11B 5/733; G11B 5/702; C08G 18/00

(52) U.S. Cl. 428/840.2; 428/844.8; 528/73; 528/67

(57) ABSTRACT

An aspect of the present invention relates to a magnetic recording medium comprising a magnetic layer comprising a ferromagnetic power and a binder on a nonmagnetic support, wherein,
the binder comprises a constituent component in the form of a polyurethane resin obtained from starting materials in the form of a polyisocyanate and a polyol denoted by general formula (I):

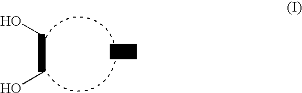

wherein, in general formula (I), Z¹ denotes an atom group forming a lactone ring with two adjacent carbon atoms.

### CROSS-REFERENCE TO RELATED APPLICATIONS

This application claims the benefit of priority under 35 USC 119 to Japanese Patent Application No. 2008-223021 filed on Sep. 1, 2008 and Japanese Patent Application No. 2009-076982 filed on Mar. 26, 2009, which are expressly incorporated herein by reference in their entirety.

### FIELD OF THE INVENTION

The present invention relates to a magnetic recording medium, more specifically, to a magnetic recording medium with excellent surface smoothness.

The present invention further relates to a binder suitable for use in a magnetic layer and/or a nonmagnetic layer of a magnetic recording medium, and to a novel polyurethane resin suitable for use as a binder for a magnetic recording medium.

### DISCUSSION OF THE BACKGROUND

In particulate magnetic recording media, the binder plays an important role in magnetic particle dispersibility, coating durability, electromagnetic characteristics, running durability, and the like.

Various resins, such as vinyl chloride resins, polyurethane resins, polyester resins, and acrylic resins are employed as binders in magnetic recording media. Of these, polyurethane resins are currently widely employed because they can increase coating strength due to intramolecular hydrogen bonds resulting from urethane bonding.

Known polyurethane resins include polyester polyurethane, polyether polyurethane, polyether ester polyurethane, and polycarbonate polyurethane. Of these polyurethane resins, polyester polyurethane is known for its good compatibility with other resins, strength, heat resistance, adhesive properties, and the like (for example, see Japanese Patent No. 3,292,252, which is expressly incorporated herein by reference in its entirety).

In recent years, means of rapidly transmitting information have become highly developed, permitting the transmission of data and images comprised of huge amounts of information. As these data transmission techniques have improved, higher density recording has been demanded of recording media and recording and reproducing devices used to record, reproduce and store information. To achieve good electromagnetic characteristics in high-density recording regions, it is effective to disperse microparticulate magnetic material to a high degree and increase the smoothness of the magnetic layer surface in addition to employing microparticulate magnetic material. The introduction of polar groups into the binder is widely employed to increase dispersibility in the magnetic layer (for example, see Japanese Unexamined Patent Publication (KOKAI) No. 2003-132531 and English language family member U.S. 2003/0143323 A1, which are expressly incorporated herein by reference in their entirety).

Research conducted by the present inventors revealed that although the dispersibility of the magnetic material increased in magnetic recording media by using binder with an increased quantity of polar groups, thereby enhancing the surface properties of the magnetic layer obtained and yielding good electromagnetic characteristics, pronounced head grime also developed during running. Research conducted by the present inventors further revealed that head grime become pronounced in systems employing polyester polyurethane containing ester bonds in the main chain.

### SUMMARY OF THE INVENTION

An aspect of the present invention provides for a magnetic recording medium capable of achieving both good surface smoothness and reduced head grime.

The present inventors conducted extensive research into achieving the above-stated magnetic recording medium, resulting in the idea that head grime might be due to the presence on the surface of the magnetic layer of low-molecular components originating in the binder. The greater the surface smoothness of the magnetic layer, the greater the area of contact between the head and the magnetic layer during running. Thus, the proportion of low-molecular component present on the outer layer of the magnetic layer adhering to the head was thought to increase.

Accordingly, the present inventors conducted further research, inferring the following mechanism by which the molecular weight of polyester polyurethane containing ester bonds in the main chain was reduced.

Active sites (acid sites and base sites) are known to be present on the surface of magnetic powder. The polyester polyurethane containing main-chain ester bonds comes into contact with active sites on the surface of the magnetic powder during the magnetic powder dispersion step, being severed by hydrolysis and diminishing in molecular weight.

By contrast, polyester polyurethane comprising side-chain ester bonds generates alcohol or carboxylic acid through contact with active sites on the surface of the magnetic powder in the magnetic powder dispersion step. In this step, when the side-chain ester is a cyclic ester (lactone), the alcohol or carboxylic acid is thought to be generated within the polymer during hydrolysis, so no low-molecular compound becomes free.

The present inventors conducted extensive research based on the above knowledge, resulting in the discovery that the use of a polyol containing a lactone ring as the diol component of polyurethane yielded a polyurethane permitting the manufacturing of a magnetic recording medium with little head grime and good surface smoothness, and devised the present invention.

An aspect of the present invention relates to a magnetic recording medium comprising a magnetic layer comprising a ferromagnetic power and a binder on a nonmagnetic support, wherein,

the binder comprises a constituent component in the form of a polyurethane resin obtained from starting materials in the form of a polyisocyanate and a polyol denoted by general formula (I):

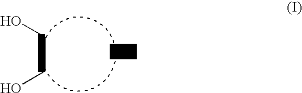

wherein, in general formula (I), Z¹ denotes an atom group forming a lactone ring with two adjacent carbon atoms.

Another aspect of the present invention relates to a magnetic recording medium comprising a nonmagnetic layer comprising a nonmagnetic powder and a binder and a magnetic layer comprising a magnetic layer and a binder in this order on a nonmagnetic support, wherein

the binder comprised in the magnetic layer and/or the binder comprised in the nonmagnetic layer comprise a constituent component in the form of a polyurethane resin obtained from starting materials in the form of a polyisocyanate and a polyol denoted by the above general formula (I).

The polyol denoted by general formula (I) may comprise a polyol denoted by general formula (II) and/or a polyol denoted by general formula (III):

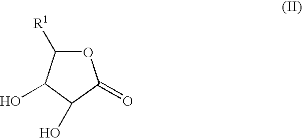

wherein, in general formula (II), R¹ denotes a hydrogen atom, hydroxyl group, or alkyl group;

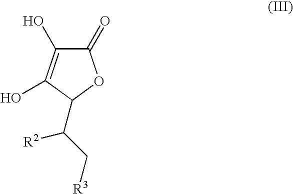

wherein, in general formula (III), each of R² and R³ independently denotes an alkoxyl group or an ester group.

The polyol denoted by general formula (III) may comprise a polyol denoted by general formula (IV):

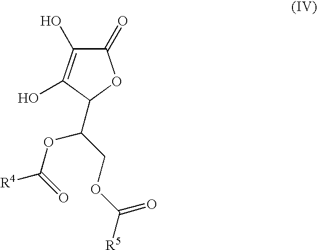

wherein, in general formula (IV), each of R⁴ and R⁵ independently denotes an alkyl group, aryl group, or heteroaryl group, and R⁴ and R⁵ may bond together to form a ring structure.

The binder may comprise a reaction product of the above polyurethane resin and a trifunctional or greater polyisocyanate.

The above polyurethane resin may comprise a sulfonic acid (salt) group in a quantity of 10 to 1,000 μeq/g.

A further aspect of the present invention relates to a binder for a magnetic recording medium, comprising a constituent component in the form of a polyurethane resin obtained from starting materials in the form of a polyisocyanate and a polyol denoted by the above general formula (I).

The polyol denoted by general formula (I) may comprise a polyol denoted by the above general formula (II) and/or a polyol denoted by the above general formula (III).

The polyol denoted by general formula (III) may comprise a polyol denoted by the above general formula (IV).

The binder may comprise a reaction product of the above polyurethane resin and a trifunctional or greater polyisocyanate.

The above polyurethane resin may comprise a sulfonic acid (salt) group in a quantity of 10 to 1,000 μeq/g.

The binder may be a binder for a nonmagnetic layer and/or a magnetic layer of a magnetic recording medium.

A still further aspect of the present invention relates to a polyurethane resin, obtained from starting materials in the form of a polyisocyanate and a polyol denoted by the above general formula (I).

The polyol denoted by general formula (I) may comprise a polyol denoted by the above general formula (II) and/or a polyol denoted by the above general formula (III).

The polyol denoted by general formula (III) may comprise a polyol denoted by the above general formula (IV).

The polyurethane resin may comprise a sulfonic acid (salt) group in a quantity of 10 to 1,000 μeq/g.

The present invention can provides a magnetic recording medium suited to high-density recording with reduced head grime in addition to good surface smoothness.

Other exemplary embodiments and advantages of the present invention may be ascertained by reviewing the present disclosure.

### DETAILED DESCRIPTIONS OF THE EMBODIMENTS

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Magnetic Recording Medium

An aspect of the present invention relates to a magnetic recording medium comprising a magnetic layer comprising a ferromagnetic power and a binder on a nonmagnetic support, wherein,

the binder comprises a constituent component in the form of a polyurethane resin obtained from starting materials in the form of a polyisocyanate and a polyol denoted by general formula (I) described further below.

Another aspect of the present invention relates to a magnetic recording medium comprising a nonmagnetic layer comprising a nonmagnetic powder and a binder and a magnetic layer comprising a magnetic layer and a binder in this order on a nonmagnetic support, wherein

the binder comprised in the magnetic layer and/or the binder comprised in the nonmagnetic layer comprise a constituent component in the form of a polyurethane resin obtained from starting materials in the form of a polyisocyanate and a polyol denoted by general formula (I) described further below.

Polyester polyurethane containing one or more lactone rings can be synthesized by reacting the lactone ring-containing polyol denoted by general formula (I) with a polyisocyanate. In such a polyester polyurethane, the ester is thought to be hydrolyzed by contact with the active sites on the magnetic powder surface in the magnetic powder dispersion step, generating carboxyl groups and hydroxyl groups on side chains (see the following scheme).

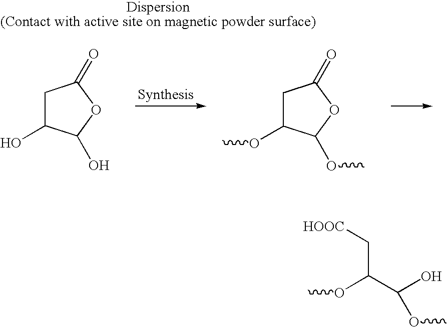

By contrast, in polyester polyurethane containing main-chain ester bonds, contact with the magnetic powder surface in the dispersion step is thought to cause the esters to hydrolyze, severing the binder and releasing low-molecular components (see the following scheme).

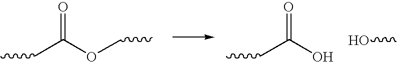

In magnetic recording media employing binder in the form of polyester polyurethane that contains main-chain ester bonds, head grime is thought to be produced by the migration of the above low-molecular components to the magnetic layer surface. By contrast, the polyol denoted by general formula (I) is thought to prevent the generation of such low-molecular components in the dispersion step, thereby inhibiting the generation of head grime.

As the result of research by the present inventors, it was revealed that the use of a polyurethane resin obtained from starting materials in the form of the polyol denoted by general formula (I) and polyisocyanate as a constituent component of the binder was effective in increasing the surface smoothness of the magnetic layer. This was thought to permit increased dispersion of the magnetic powder by generating polar groups in the form of carboxyl groups in the dispersion step, as set forth above.

Further, increasing the dispersibility of the nonmagnetic powder contained in the nonmagnetic layer positioned beneath the magnetic layer is effective to increase the smoothness of the magnetic layer surface in a multilayered magnetic recording medium comprising a nonmagnetic layer and a magnetic layer. Research conducted by the present inventors revealed that when the above polyurethane resin was employed as a constituent component of the binder in the nonmagnetic layer, the smoothness of the nonmagnetic layer surface could be increased. This was attributed to reasons identical or similar to those set forth above.

The present invention as set forth above can yield a magnetic recording medium achieving both good surface smoothness and reduced head grime.

The above binder will be described in greater detail below.

The binder can contain the polyurethane resin obtained from starting materials in the form of the polyol denoted by general formula (I) and polyisocyanate, and/or a reaction product of the above polyurethane resin and another binder component. Examples of other binder components are components generally known as curing agents or crosslinking agents, such as polyisocyanates. These will be described in detail further below.

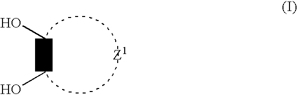

In general formula (I), Z¹ denotes an atom group forming a lactone ring with two adjacent carbon atoms. The lactone ring that is formed is not specifically limited, other than that it contains an ester bond as part of the ring. From the perspective of the dispersion-enhancing effect, a five or six-membered lactone ring is desirable. In general formula (I), the bond denoted by “ . . . ” between the two carbon atoms bonded to the hydroxyl group denotes a single bond or a double bond.

The polyol denoted by general formula (II) below and the polyol denoted by general formula (III) below are desirable embodiments of the polyol denoted by general formula (I).

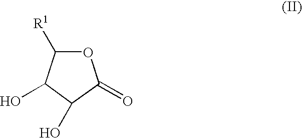

In general formula (II), R¹ denotes a hydrogen atom, hydroxyl group, or alkyl group.

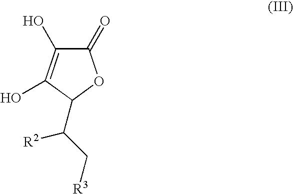

In general formula (III), each of R² and R³ independently denotes an alkoxyl group or an ester group.

General formulas (II) and (III) will be described in greater detail. In the present invention, the term “alkyl group” includes cyclic alkyl groups such as cycloalkyl groups and bicycloalkyl groups. When there is a substituent on a group such as an alkyl group, examples of the substituent are alkyl groups, hydroxyl groups, alkoxy groups, halogen atoms, and carboxyl groups. The number of carbon atoms of a group such as an alkyl group refers to the number of carbon atoms of the portion without the substituent when a substituent is present on the group.

In general formula (II), R¹ denotes a hydrogen atom, hydroxyl group, or alkyl group. Alkyl groups denoted by R¹ may be linear or branched substituted or unsubstituted alkyl groups. Desirable examples are alkyl groups having 1 to 30 carbon atoms, such as methyl, ethyl, n-propyl, isopropyl, t-butyl, n-octyl, eicosyl, 2-chloroethyl, 2-cyanoethyl, and 2-ethylhexyl groups.

In general formula (III), each of R¹ and R³ independently denotes an alkoxyl group or an ester group. Desirable examples of alkoxyl groups are substituted or unsubstituted alkoxyl groups having 1 to 30 carbon atoms, such as methoxy, ethoxy, isopropoxy, t-butoxy, n-octyloxy, and 2-methoxyethoxy groups. Examples of ester groups denoted by R² and R³ are the esters groups contained in general formula (IV), described further below. In general formula (III), R² and R³ may bond together to form a ring structure.

The following diol is a specific example of the polyol denoted by general formula (II).

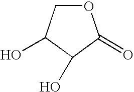

Among the polyols denoted by general formula (III), the following polyol is a specific example of the polyol in which each of R² and R³ independently denotes an alkoxyl group.

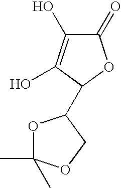

Among the polyols denoted by general formula (III), the polyol denoted by general formula (IV) is an example of the polyol in which each of R and R independently denotes an ester group.

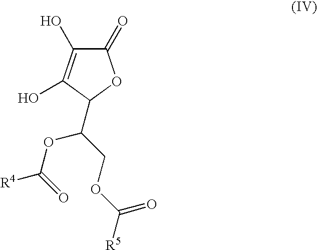

In general formula (IV), each of R⁴ and R⁵ independently denotes an alkyl group, aryl group, or heteroaryl group, and R⁴ and R⁵ may bond together to form a ring structure. Details of general formula (IV) will be described below.

In general formula (IV), each of R⁴ and R⁵ independently denotes an alkyl group, aryl group, or heteroaryl group. Examples of alkyl groups denoted by R⁴ and R⁵ are: methyl, ethyl, n-propyl, isopropyl, t-butyl, n-octyl, eicosyl, 2-chloroethyl, 2-cyanoethyl, 2-ethylhexyl, decanyl, undecanyl, dodecanyl, tridecanyl, tetradecanyl, hexadecanyl, octadecanyl, nonadecanyl, eicosanyl, docosanyl, 3-nonyldodecanyl, 3-undecyltetradecanyl, 2-decyldodecanyl, 2-dodecyltetradecanyl, and cyclohexyl groups.

The aryl groups denoted by R⁴ and R⁵ are substituted or unsubstituted aryl groups, desirably aryl groups having 6 to 30 carbon atoms, preferably 6 to 20 carbon atoms, and more preferably, 6 to 12 carbon atoms, such as phenyl, p-methylphenyl, 1-naphthyl, 2-naphthyl, 1-anthranyl, 2-anthranyl, 5-anthranyl, and biphenyl groups.

The heteroaryl groups denoted by R⁴ and R⁵ are substituted or unsubstituted heteroaryl groups desirably having 1 to 20 carbon atoms, preferably having 2 to 15 carbon atoms, and more preferably, having 4 to 10 carbon atoms, such as 2-pyridyl, 3-pyridyl, 4-pyridyl, bipyridyl, 5-methylpyridyl, thienyl, and furyl groups.

The present inventors assume that among the polyols denoted by general formula (I), the polyols denoted by general formula (IV) are advantageous in increasing coating strength for the following reasons.

The polyols denoted by general formula (IV) can be reacted with a polyisocyanate to synthesize polyester polyurethane comprising one or morelactone rings. The fact that the ester in such a polyester polyurethane hydrolyzes upon contact with active sites on the magnetic powder surface in the magnetic powder dispersion step, generating side-chain carboxyl groups and hydroxyl groups has been set forth above. Further, two hydroxyl groups are also thought to be generated by hydrolysis of side-chain esters (see the scheme below).

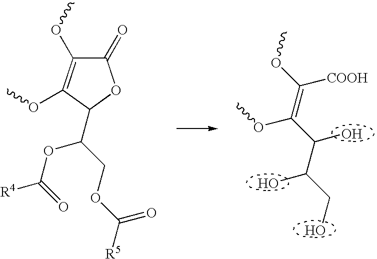

In the above scheme, the hydroxyl groups enclosed in dotted lines are thought to contribute to increasing the coating strength by reacting with the polyisocyanate employed as a curing agent or crosslinking agent, described further below. Thus, the polyol denoted by general formula (IV) comprises two ester groups, and is thought to produce two hydroxyl groups in addition to the hydroxyl group generated by opening the lactone ring. That is, the polyurethane resin derived from the polyol denoted by general formula (IV) can generate three hydroxyl groups for each lactone ring, and is thus thought to be more highly reactive with polyisocyanate and form a stronger coating than polyurethane resin derived from other polyols denoted by general formula (I).

As will be set forth further below, compounds comprising carboxyl groups can function as so-called surface-modifying agents to increase the dispersibility of ferromagnetic powder. When the ester group on the side chain in general formula (IV) undergoes the above-described hydrolysis, carboxylic acid is thought to be released (see the scheme below).

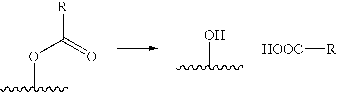

The free carboxylic acid is thought to function as a surface-modifying agent. Thus, among compounds denoted by general formula (I), the compound denoted by general formula (IV) is presumed to be advantageous in increasing dispersibility.

Dipalmitoyl ascorbic acid is a specific example of the polyol denoted by general formula (IV).

The polyols denoted by general formula (I) can be synthesized by known methods, and are in some cases available as commercial products. For synthesis methods, reference can be made to, for example, J. Org. Chem., Vol. 56, No. 21, 1991, which is expressly incorporated herein by reference in its entirety.

The starting materials of the above polyurethane resin are a polyol denoted by general formula (I) and a polyisocyanate. Examples of polyisocyanates that can be employed as starting materials are: aromatic diisocyanates such as diphenylmethane diisocyanate (MDI), 2,4-trilene diisocyanate (2,4-TDI), 2,6-TDI, 1,5-naphthalene diisocyanate (1,5-NDI), tolidine diisocyanate (TODI), p-phenylene diisocyanate, and xylylene diisocyanate (XDI); and aliphatic and alicyclic diisocyanates such as transcyclohexane 1,4-diisocyanate, hexamethylene diisocyanate (HDI), isophorone diisocyanate (IPDI), hydrogenated xylylene diisocyanate (H₆XDI), and hydrogenated diphenylmethane diisocyanate (H₁₂MDI).

In addition to a polyol denoted by general formula (I) and a polyisocyanate, the above starting materials may further comprise a polyol other than a polyol denoted by general formula (I). The polyol that is employed in combination can perform a role as a chain-extending agent. Examples of polyols employed in combination are the various polyols employed as polyurethane starting materials; specific examples are linear aliphatic diols such as ethylene glycol, propylene glycol, trimethylene glycol, 1,4-butanediol, 1,6-hexanediol, neopentyl glycol, monoolein, monoacetin, pentaerythritol distearate, and pentaerythritol dioleate; diols having repeating units in the form of alicyclic structures such as 1,4-cyclohexanedimethanol, hydrogenated bisphenol A, and tricyclodecanedimethanol; aromatic diols such as bisphenol A and xylylene diol; (poly)ether glycols such as diethylene glycol, triethylene glycol, polyethylene glycol, and polytetramethylene glycol; and polycarbonate polyols. As set forth above, among the polyester polyurethanes that are conventionally employed as binders in magnetic recording media, those comprising a main-chain ester bond are thought to tend to undergo binder severing in the dispersion step. By contrast, a polyurethane resin having as a starting material the polyol denoted by general formula (I) tends to produce little head grime even when containing a main-chain ester bond. This is attributed to suppression of severing of the main-chain ester bond due to the presence of a lactone ring on the skeleton. Accordingly, the polyurethane resin may also comprise a main-chain ester bond. However, from the perspective of further reducing head grime, the polyurethane resin desirably does not comprise a main-chain ester bond. To obtain a polyurethane resin that does not have a main-chain ester bond, the polyol that is employed in combination desirably does not have an acyclic ester group on the main chain.

The content of the polyol denoted by general formula (I) in the above starting materials is desirably equal to or higher than 0.01 weight percent from the perspective of reactivity with the curing agent, and desirably equal to or lower than 10.0 weight percent from the perspective of dispersibility. This content is preferably 0.7 to 5.0 weight percent. The contents of the polyol employed in combination and the polyisocyanate can be suitably established. For example, the content in the starting materials of the polyol employed in combination can be 45.0 to 70.0 weight percent, and the content of the polyisocyanate can be 23.0 to 49.0 weight percent.

The molecular weight of the polyurethane resin, as a weight average molecular weight, desirably falls within a range of 15,000 to 200,000. From the perspective of suppressing head grime, it is desirably equal to or greater than 30,000. From the perspective of dispersibility, it is desirably equal to or lower than 180,000, and preferably 50,000 to 150,000. A polyurethane resin with a weight average molecular weight falling within the above range can afford high solvent solubility and good dispersibility, and permit the formation of a magnetic recording medium of high coating strength. The ratio of the weight average molecular weight to the number average molecular weight (Mw/Mn) is desirably equal to or less than 5, preferably falling within a range of 1.4 to 4.0. In the present invention, the average molecular weight refers to the value obtained by standard polystyrene conversion. The molecular weight of the polyurethane resin can be controlled by means of the starting material composition, reaction conditions, and the like.

The above polyurethane resin can generate carboxyl groups on side chains during the dispersion step as set forth above, thereby enhancing dispersibility. For further improved dispersibility, it is possible to incorporate a functional (polar) group that adsorbs to the powder surface. Functional groups that can be incorporated include: —SO₃M, —SO₄M, —PO(OM)₂, —OPO(OM)₂, —COOM, >NSO₃M, >NRSO₃M, —NR¹R², and —N′R¹R²R³X⁻. M denotes hydrogen or an alkali metal such as Na or K. R denotes an alkylene group. R¹, R², and R³ denote alkyl groups, hydroxyalkyl groups, or hydrogen atoms. X denotes a halogen atom such as Cl or Br. The quantity of functional groups in the polyurethane resin is desirably 10 to 200 μeq/g, preferably 30 to 120 μeq/g.

Functional groups that are desirably incorporated into the polyurethane resin are the sulfonic acid group (—SO₃H) and sulfonate groups such as SO₃Na, SO₃K, and SO₃Li groups (in the present invention, the term “sulfonic acid (salt) group” includes sulfonic acid group and sulfonate group); the carboxylic acid group (—COOH) and carboxylate groups such as COONa, COOK, and COOLi groups (in the present invention, the term “carboxylic acid (salt) group” includes the carboxylic acid group and carboxylate group). Sulfonic acid (salt) groups are desirably incorporated as functional groups. The quantity incorporated is desirably 10 to 1,000 μeq/g. When incorporating a functional group in the form of a carboxylic acid (salt) group, the quantity incorporated is desirably 10 to 1,000 μeq/g in combination with the lactone ring.

The functional group can be incorporated into the polyurethane resin by a known method. Examples of methods of incorporation are the method of using a polyol having the above functional group as part of the above starting materials, and the method of incorporating the functional group in a polymer reaction after polymerizing the polyurethane. Examples are the diols employed in Examples as sulfonic acid (salt) group-containing diols. Examples of carboxylic acid (salt) group-containing diols are 2,2-bis(hydroxymethyl)butyric acid, 2,2-bis(hydroxyethyl)butyric acid, and the diols employed in Examples.

The polyurethane resin can be obtained by reacting the starting materials by a known method. Reference can be made to Examples described further below for synthesis methods.

A thermosetting compound is normally employed as a curing agent (also known as a “crosslinking agent”) to crosslink and cure the binder resin and increase the coating strength in a magnetic recording medium. Polyisocyanate compounds are widely employed as curing agents. However, isocyanate and alcohol react in normal urethane synthesis, leaving almost no alcohol in the polyurethane so that it tends not to react with the curing agent. By contrast, in the above polyurethane resin, hydroxyl groups can be produced along with carboxyl groups by opening of the lactone ring in the dispersion step, and the reaction of these hydroxyl groups with the isocyanate is thought to contribute to strengthening of the coating. Accordingly, from the perspective of increasing the coating strength, the polyurethane resin is desirably employed in combination with polyisocyanate. As set forth above, polyurethane resin derived from the polyol denoted by general formula (IV) can produce three hydroxyl groups per lactone ring, and is thus preferably employed in combination with polyisocyanate.

A magnetic recording medium containing the above-described polyurethane resin as binder component can be obtained by forming a magnetic layer or nonmagnetic layer by adding the polyurethane resin without polyisocyanate to a magnetic coating material or nonmagnetic coating material. Additionally, a magnetic recording medium containing the reaction product of the polyurethane resin and polyisocyanate as binder component can be obtained by adding polyisocyanate along with the polyurethane resin to the magnetic coating material or nonmagnetic coating material because a curing (crosslinking) reaction proceeds due to heat (calendering, thermal processing, or the like) after coating. In the magnetic recording medium of the present invention, the incorporation of the reaction product of the above polyurethane resin and polyisocyanate as binder component in the magnetic layer and/or nonmagnetic layer is desirable to increase coating strength and enhance running durability.

Examples of polyisocyanates are bifunctional or greater polyisocyanates, such as tolylene diisocyanate, 4,4′-diphenylmethane diisocyanate, hexamethylene diisocyanate, xylylene diisocyanate, napthylene-1,5-diisocyanate, o-toluidine diisocyanate, isophorone diisocyanate, triphenylmethane triisocyanate, and other isocyanates; products of these isocyanates and polyalcohols; polyisocyanates produced by condensation of isocyanates; and the like. These isocyanates are commercially available under the following trade names, for example: Coronate L, Coronate HL, Coronate 2030, Coronate 2031, Millionate MR and Millionate MTL manufactured by Nippon Polyurethane Industry Co. Ltd.; Takenate D-102, Takenate D-110N, Takenate D-200 and Takenate D-202 manufactured by Takeda Chemical Industries Co., Ltd.; and Desmodule L, Desmodule IL, Desmodule N and Desmodule HL manufactured by Sumitomo Bayer Co., Ltd. They can be used in each layer singly or in combinations of two or more by exploiting differences in curing reactivity.

From the perspective of increasing coating strength, the use of a trifunctional or greater polyisocyanate as the polyisocyanate is desirable. Specific examples of trifunctional or greater polyisocyanates are adduct polyisocyanate compounds such as a compound in which three mols of trilene diisocyanate (TDI) have been added to trimethylolpropane (TMP), a compound in which three mols of hexamethylene diisocyanate (HDI) have been added to TMP, a compound in which 3 mols of isophorone diisocyanate (IPDI) have been added to TMP, and a compound in which 3 mols of xylylene diisocyanate (XDI) have been added to TMP; a condensed isocyanurate trimer of TDI; a condensed isocyanurate pentamer of TDI; a condensed isocyanurate heptamer of TDI; and mixtures thereof. Further examples are isocyanurate condensation products of HDI, isocyanurate condensation products of IPDI, and crude MDI. The quantity of curing agent employed is, for example, 0 to 80 weight parts per 100 weight parts of the polyurethane resin.

The magnetic recording medium of the present invention can comprise, as a constituent component of the binder in the magnetic layer and/or in the nonmagnetic layer, known thermoplastic resins, thermosetting resins, reactive resins, and the like. Specific examples of thermoplastic resins are polymers and copolymers containing structural units in the form of vinyl chloride, vinyl acetate, vinyl alcohol, maleic acid, acrylic acid, acrylic ester, vinylidene chloride, acrylonitrile, methacrylic acid, methacrylic ester, styrene, butadiene, ethylene, vinyl butyral, vinyl acetal, and vinyl ether; and various rubber resins. Examples of thermosetting resins and reactive resins are phenol resin, epoxy resin, polyurethane cured resin, urea resin, melamine resin, alkyd resin, acrylic reaction resin, formaldehyde resin, silicone resin, epoxy-polyamide resin, mixtures of polyester resin and isocyanate prepolymer, mixtures of polyester polyol and polyisocyanate, and mixtures of polyurethane and polyisocyanate. These resins are described in detail in the “Plastic Handbook” released by Asakura Shoten, which is expressly incorporated herein by reference in its entirety. Known e-beam-setting resins may also be employed in the various layers. Examples of such resins and their manufacturing methods are described in detail in Japanese Unexamined Patent Publication (KOKAI) Showa No. 62-256219, which is expressly incorporated herein by reference in its entirety. The above-described resins can be employed singly or in combination of two or more.

The quantity of binder employed in the magnetic layer and the nonmagnetic layer ranges from, for example, 5 to 50 weight percent, preferably from 10 to 30 weight percent, relative to the nomnagnetic powder or magnetic powder. The quantity of the above polyurethane resin derived from the polyol denoted by general formula (I) desirably ranges from 5 to 30 weight percent, preferably from 10 to 20 weight percent, relative to the nonmagnetic powder or magnetic powder. By employing the above polyurethane resin in a quantity within the above-described range, dispersibility can be effectively improved.

Details of the magnetic recording medium will be described below.

### (Magnetic Layer)

In the magnetic recording medium of the present invention, the ferromagnetic powder contained in the magnetic layer can be a ferromagnetic hexagonal ferrite powder or a ferromagnetic metal powder.

The average particle size of the ferromagnetic powder can be measured by the following method.

Particles of ferromagnetic powder are photographed at a magnification of 100,000-fold with a model H-9000 transmission electron microscope made by Hitachi and printed on photographic paper at a total magnification of 500,000-fold to obtain particle photographs. The targeted magnetic material is selected from the particle photographs, the contours of the powder material are traced with a digitizer, and the size of the particles is measured with KS-400 image analyzer software from Carl Zeiss. The size of 500 particles is measured. The average value of the particle sizes measured by the above method is adopted as an average particle size of the ferromagnetic powder.

The size of a powder such as the magnetic material (referred to as the “powder size” hereinafter) in the present invention is denoted: (1) by the length of the major axis constituting the powder, that is, the major axis length, when the powder is acicular, spindle-shaped, or columnar in shape (and the height is greater than the maximum major diameter of the bottom surface); (2) by the maximum major diameter of the tabular surface or bottom surface when the powder is tabular or columnar in shape (and the thickness or height is smaller than the maximum major diameter of the tabular surface or bottom surface); and (3) by the diameter of an equivalent circle when the powder is spherical, polyhedral, or of unspecified shape and the major axis constituting the powder cannot be specified based on shape. The “diameter of an equivalent circle” refers to that obtained by the circular projection method.

The average powder size of the powder is the arithmetic average of the above powder size and is calculated by measuring five hundred primary particles in the above-described method. The term “primary particle” refers to a nonaggregated, independent particle.

The average acicular ratio of the powder refers to the arithmetic average of the value of the (major axis length/minor axis length) of each powder, obtained by measuring the length of the minor axis of the powder in the above measurement, that is, the minor axis length. The term “minor axis length” means the length of the minor axis constituting a powder for a powder size of definition (1) above, and refers to the thickness or height for definition (2) above. For (3) above, the (major axis length/minor axis length) can be deemed for the sake of convenience to be 1, since there is no difference between the major and minor axes.

When the shape of the powder is specified, for example, as in powder size definition (1) above, the average powder size refers to the average major axis length. For definition (2) above, the average powder size refers to the average plate diameter, with the arithmetic average of (maximum major diameter/thickness or height) being referred to as the average plate ratio. For definition (3), the average powder size refers to the average diameter (also called the average particle diameter). In the measurement of powder size, the standard deviation/average value, expressed as a percentage, is defined as the coefficient of variation.

Examples of hexagonal ferrite powders are barium ferrite, strontium ferrite, lead ferrite, calcium ferrite, and various substitution products thereof such as Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite powder in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and the like. Compounds to which elements such as Co—Zn, Co—Ti, Co—Ti—Zr, Co—Ti—Zn, Ni—Ti—Zn, Nb—Zn—Co, Sb—Zn—Co, and Nb—Zn have been added may generally also be employed. They may comprise specific impurities depending on the starting materials and manufacturing methods employed.

The average plate diameter of the hexagonal ferrite powder preferably ranges from 10 to 100 nm, more preferably 10 to 60 nm, further preferably 10 to 50 nm. Particularly when employing an MR head in reproduction to increase a track density, an average plate diameter equal to or less than 60 nm is desirable to reduce noise, with equal to or less than 50 nm being preferred. An average plate diameter equal to or higher than 10 nm can yield stable magnetization without the effects of thermal fluctuation. An average plate diameter equal to or less than 100 nm can permit low noise and is suited to the high-density magnetic recording. The average plate ratio (plate diameter/plate thickness) of the hexagonal ferrite powder preferably ranges from 1 to 15, more preferably from 1 to 7. Low plate ratio is preferable to achieve high filling property of the magnetic layer, but sometimes adequate orientation is not achieved. When the plate ratio is higher than 15, noise may be increased due to stacking between particles. The specific surface area by BET method of the hexagonal ferrite powders having such particle sizes normally ranges from 10 to 100 m²/g, almost corresponding to an arithmetic value from the particle plate diameter and the plate thickness. Narrow distributions of particle plate diameter and thickness are normally good. Although difficult to render in number form, about 500 particles can be randomly measured in a transmission electron microscope (TEM) photograph of particles to make a comparison. This distribution is often not a normal distribution. However, when the distribution is expressed as the standard deviation σ to the average particle size, σ/average particle size=0.1 to 2.0. The particle producing reaction system is rendered as uniform as possible and the particles produced are subjected to a distribution-enhancing treatment to achieve a narrow particle size distribution. For example, methods such as selectively dissolving ultrafine particles in an acid solution by dissolution are known.

A coercivity (He) of the hexagonal ferrite powder of about 500 to 5,000 Oe (about 40 to 398 kA/m) can normally be achieved. A high coercivity (Hc) is advantageous for high-density recording, but this is limited by the capacity of the recording head. The hexagonal ferrite powder employed in the present invention preferably has a coercivity (He) ranging from 2,000 to 4,000 Oe (about 160 to 320 kA/m), more preferably 2,200 to 3,500 Oe (about 176 to 280 kA/m). When the saturation magnetization of the head exceeds 1.4 tesla, the hexagonal ferrite having a coercivity (He) of equal to or higher than 2,200 Oe (about equal to or higher than 176 kA/m) is preferably employed. The coercivity (He) can be controlled by particle size (plate diameter and plate thickness), the types and quantities of elements contained, substitution sites of the element, the particle producing reaction conditions, and the like. The saturation magnetization (σₛ) can be 40 to 80 A·m²/kg. The higher saturation magnetization (σₛ) is preferred, however, it tends to decrease with decreasing particle size. Known methods of improving saturation magnetization (σₛ) are combining spinel ferrite with magnetoplumbite ferrite, selection of the type and quantity of elements incorporated, and the like. It is also possible to employ W-type hexagonal ferrite. When dispersing the hexagonal ferrite powder, the surface of the hexagonal ferrite powder can be processed with a substance suited to a dispersion medium and a polymer. Both organic and inorganic compounds can be employed as surface treatment agents. Examples of the principal compounds are oxides and hydroxides of Si, Al, P, and the like; various silane coupling agents; and various titanium coupling agents. The quantity of surface treatment agent added can range from 0.1 to 10 weight percent relative to the weight of the hexagonal ferrite powder. The pH of the hexagonal ferrite powder can also be important to dispersion. A pH of about 4 to 12 is usually optimum for the dispersion medium and polymer From the perspective of the chemical stability and storage properties of the medium, a pH of about 6 to 11 can be selected. Moisture contained in the hexagonal ferrite powder also affects dispersion. There is an optimum level for the dispersion medium and polymer, usually selected from the range of 0.01 to 2.0 weight percent. Methods of manufacturing the hexagonal ferrite powder include: (1) a vitrified crystallization method consisting of mixing into a desired ferrite composition barium oxide, iron oxide, and a metal oxide substituting for iron with a glass forming substance such as boron oxide; melting the mixture; rapidly cooling the mixture to obtain an amorphous material; reheating the amorphous material; and refining and comminuting the product to obtain a barium ferrite crystal powder; (2) a hydrothermal reaction method consisting of neutralizing a barium ferrite composition metal salt solution with an alkali; removing the by-product; heating the liquid phase to 100° C. or greater; and washing, drying, and comminuting the product to obtain barium ferrite crystal powder; and (3) a coprecipitation method consisting of neutralizing a barium ferrite composition metal salt solution with an alkali; removing the by-product; drying the product and processing it at equal to or less than 1,100° C.; and comminuting the product to obtain barium ferrite crystal powder However, any manufacturing method can be selected in the present invention.

The ferromagnetic metal powder employed in the magnetic layer is not specifically limited, but preferably a ferromagnetic metal power comprised primarily of α-Fe. In addition to prescribed atoms, the following atoms can be contained in the ferromagnetic metal powder: Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B and the like. Particularly, incorporation of at least one of the following in addition to α-Fe is desirable: Al, Si, Ca, Y, Ba, La, Nd, Co, Ni, and B. Incorporation of at least one selected from the group consisting of Co, Y and Al is particularly preferred. The Co content preferably ranges from 0 to 40 atom percent, more preferably from 15 to 35 atom percent, further preferably from 20 to 35 atom percent with respect to Fe. The content of Y preferably ranges from 1.5 to 12 atom percent, more preferably from 3 to 10 atom percent, further preferably from 4 to 9 atom percent with respect to Fe. The Al content preferably ranges from 1.5 to 12 atom percent, more preferably from 3 to 10 atom percent, further preferably from 4 to 9 atom percent with respect to Fe.

These ferromagnetic metal powders may be pretreated prior to dispersion with dispersing agents, lubricants, surfactants, antistatic agents, and the like, described further below. Specific treatment examples are described in Japanese Examined Patent Publication (KOKOKU) Showa Nos. 44-14090, 45-18372, 47-22062, 47-22513, 46-28466, 46-38755, 47-4286, 47-12422, 47-17284, 47-18509, 47-18573, 39-10307, and 46-39639; and U.S. Pat. Nos. 3,026,215, 3,031,341, 3,100,194, 3,242,005, and 3,389,014, which are expressly incorporated herein by reference in their entirety.

The ferromagnetic metal powder may contain a small quantity of hydroxide or oxide. Ferromagnetic metal powders obtained by known manufacturing methods may be employed. The following are examples of methods of manufacturing ferromagnetic metal powders: methods of reduction with compound organic acid salts (chiefly oxalates) and reducing gases such as hydrogen; methods of reducing iron oxide with a reducing gas such as hydrogen to obtain Fe or Fe—Co particles or the like; methods of thermal decomposition of metal carbonyl compounds; methods of reduction by addition of a reducing agent such as sodium boron hydride, hypophosphite, or hydrazine to an aqueous solution of ferromagnetic metal; and methods of obtaining powder by vaporizing a metal in a low-pressure inert gas. Ferromagnetic metal powders thus obtained can be subjected to slow oxidation by a known method of slow oxidation, for example, immersing the ferromagnetic metal powder thus obtained in an organic solvent and drying it; the method of immersing the ferromagnetic metal powder in an organic solvent, feeding in an oxygen-containing gas to form a surface oxide film, and then conducting drying; and the method of adjusting the partial pressures of oxygen gas and an inert gas without employing an organic solvent to form a surface oxide film.

The specific surface area by BET method of the ferromagnetic metal powder employed in the magnetic layer is preferably 45 to 100 m²/g, more preferably 50 to 80 m²/g. At 45 m²/g and above, low noise can be achieved. At 100 m²/g and below, good surface properties can be achieved. The crystallite size of the ferromagnetic metal powder is preferably 80 to 180 Angstroms, more preferably 100 to 180 Angstroms, and still more preferably, 110 to 175 Angstroms. The average major axis length of the ferromagnetic metal powder is preferably equal to or greater than 0.01 micrometer and equal to or less than 0.15 micrometer, more preferably equal to or greater than 0.02 micrometer and equal to or less than 0.15 micrometer, and still more preferably, equal to or greater than 0.03 micrometer and equal to or less than 0.12 micrometer. The average acicular ratio of the ferromagnetic metal powder is preferably equal to or greater than 3 and equal to or less than 15, more preferably equal to or greater than 5 and equal to or less than 12. The as of the ferromagnetic metal powder is preferably 100 to 180 A·m²/kg, more preferably 110 to 170 A·m²/kg, and still more preferably, 125 to 160 A·m²/kg. The coercivity of the ferromagnetic metal powder is preferably 2,000 to 3,500 Oe (about 160 to 280 kA/m), more preferably 2,200 to 3,000 Oe (about 176 to 240 kA/m).

The moisture content of the ferromagnetic metal powder is desirably equal to or more than one equivalent relative to the lactone skeleton, desirably 0.01 to 2 percent. The moisture content of the ferromagnetic metal powder is desirably optimized based on the type of binder. The pH of the ferromagnetic metal powder is desirably optimized depending on the type of binder employed together. A pH range of 4 to 12 can be established, with 6 to 10 being preferred. As needed, the ferromagnetic metal powder can be surface treated with Al, Si, P, or an oxide thereof. The quantity of surface treatment can be set to 0.1 to 10 percent of the ferromagnetic metal powder. When applying a surface treatment, the quantity of a lubricant such as a fatty acid that is adsorbed is desirably not greater than 100 mg/m². The ferromagnetic metal powder will sometimes contain inorganic ions such as soluble Na, Ca, Fe, Ni, or Sr. These are desirably substantially not present in the ferromagnetic metal powder, but seldom affect characteristics at 200 ppm or less. The ferromagnetic metal powder employed in the present invention desirably has few voids; the void level is preferably 20 volume percent or less, more preferably 5 volume percent or less. As stated above, so long as the particle size characteristics are satisfied, the ferromagnetic metal powder may be acicular, rice grain-shaped, or spindle-shaped. The SFD of the ferromagnetic metal powder itself is desirably low, with 0.8 or less being preferred. The coercivity (Hc) distribution of the ferromagnetic metal powder is desirably kept low. When the SFD is 0.8 or lower, good electromagnetic characteristics can be achieved, output can be high, and magnetic inversion can be sharp, with little peak shifting, in a manner suited to high-density digital magnetic recording. To keep the coercivity (He) distribution low, the methods of improving the particle size distribution of goethite in the ferromagnetic metal powder and preventing sintering may be employed.

### (Nonmagnetic Layer)

In one aspect of the present invention, the magnetic recording medium of the present invention comprises a nonmagnetic layer comprising a nonmagnetic powder and a binder between the magnetic layer and the nonmagnetic support. In this aspect, the binder of the magnetic layer and/or that of the nonmagnetic layer comprise the above polyurethane resin derived from the polyol denoted by general formula (I) as a constituent component.

The nonmagnetic layer, so long as it is essentially nonmagnetic, is not specifically limited, and may contain magnetic powder to the extent that it remains essentially nomnagnetic. The term “essentially nonmagnetic” means that the nonmagnetic layer may possess magnetism to the extent that the electromagnetic characteristics of the magnetic layer are essentially not diminished. For example, a residual magnetic flux density of equal to or less than 0.01 T or a coercivity of equal to or less than 7.96 kA/m (about 100 Oe) is acceptable, with no residual magnetic flux density or coercivity at all being preferred.

The nonmagnetic powder comprised in the nonmagnetic layer can be selected from inorganic compounds such as metal oxides, metal carbonates, metal sulfates, metal nitrides, metal carbides, metal sulfides and the like. Examples of inorganic compounds are α-alumina having an α-conversion rate of 90 to 100 percent, β-alumina, γ-alumina, θ-alumina silicon carbide, chromium oxide, cerium oxide, α-iron oxide, hematite, goethite, corundum, silicon nitride, titanium carbide, titanium dioxide, silicon dioxide, tin oxide, magnesium oxide, tungsten oxide, zirconium oxide, boron nitride, zinc oxide, calcium carbonate, calcium sulfate, barium sulfate and molybdenum disulfide; these may be employed singly or in combination. Particularly desirable are titanium dioxide, zinc oxide, iron oxide and barium sulfate due to their narrow particle distribution and numerous means of imparting functions. Even more preferred is titanium dioxide and α-iron oxide. The average particle diameter of these nonmagnetic powders preferably ranges from 0.005 to 2 micrometers, but nonmagnetic powders of differing particle size may be combined as needed, or the particle diameter distribution of a single nonmagnetic powder may be broadened to achieve the same effect. What is preferred most is an average particle diameter in the nonmagnetic powder ranging from 0.01 to 0.2 micrometer. Particularly when the nonmagnetic powder is a granular metal oxide, an average particle diameter equal to or less than 0.08 micrometer is preferred, and when an acicular metal oxide, the average major axis length is preferably equal to or less than 0.3 micrometer, more preferably equal to or less than 0.2 micrometer. The tap density preferably ranges from 0.05 to 2 g/ml, more preferably from 0.2 to 1.5 g/ml. The moisture content of the nonmagnetic powder preferably ranges from 0.1 to 5 weight percent, more preferably from 0.2 to 3 weight percent, further preferably from 0.3 to 1.5 weight percent. The pH of the nonmagnetic powder preferably ranges from 2 to 11, and the pH between 5.5 to 10 is particular preferred.

The specific surface area of the nonmagnetic powder preferably ranges from 1 to 100 m²/g, more preferably from 5 to 80 m²/g, further preferably from 10 to 70 m²/g. The crystallite size of the nonmagnetic powder preferably ranges from 0.004 micrometer to 1 micrometer, further preferably from 0.04 micrometer to 0.1 micrometer. The oil absorption capacity using dibutyl phthalate (DBP) preferably ranges from 5 to 100 ml/100 g, more preferably from 10 to 80 ml/100 g, further preferably from 20 to 60 ml/100 g. The specific gravity of the nonmagnetic powder preferably ranges from 1 to 12, more preferably from 3 to 6. The shape of the nonmagnetic powder may be any of acicular, spherical, polyhedral, or plate-shaped. The nonmagnetic powder having a Mohs' hardness ranging from 4 to 10 is preferred. The stearic acid (SA) adsorption capacity of the nonmagnetic powder preferably ranges from 1 to 20 micromol/m², more preferably from 2 to 15 micromol/m2, further preferably from 3 to 8 micromol/m². The pH of the nonmagnetic powder preferably ranges from 3 to 6. The surface of these nonmagnetic powders is preferably treated with Al₂O₃, SiO₂, TiO₂, ZrO₂, SnO₂, Sb₂O₃, ZnO and Y₂O₃. The surface-treating agents of preference with regard to dispersibility are Al₂O₃, SiO₂, TiO₂ and ZrO₂, and Al₂O₃, SiO₂ and ZrO₂ are preferable. These may be used singly or in combination. Depending on the objective, a surface-treatment coating layer with a coprecipitated material may also be employed, the coating structure which comprises a first alumina coating and a second silica coating thereover or the reverse structure thereof may also be adopted. Depending on the objective, the surface-treatment coating layer may be a porous layer, with homogeneity and density being generally desirable.

Specific examples of nonmagnetic powders are: Nanotite from Showa Denko K. K.; HIT-100 and ZA-G1 from Sumitomo Chemical Co., Ltd.; α-hematite DPN-250, DPN-250BX, DPN-245, DPN-270BX, DPN-500BX, DBN-SA1 and DBN-SA3 from Toda Kogyo Corp.; titanium oxide TTO-51B, TTO-55A, TTO-55B, TTO-55C, TTO-55S, TTO-55D, SN-100, a-hematite E270, E271, E300 and E303 from Ishihara Sangyo Co., Ltd.; titanium oxide STT-4D, STT-30D, STT-30, STT-65C, and α-hematite α-40 from Titan Kogyo K. K.; MT-100S, MT-100T, MT-150W, MT-500B, MT-600B, MT-100F, and MT-500HD from Tayca Corporation; FINEX-25, BF-1, BF-10, BF-20, and ST-M from Sakai Chemical Industry Co., Ltd.; DEFIC-Y and DEFIC-R from Dowa Mining Co., Ltd.; AS2BM and TiO₂P25 from Nippon Aerogil; 100A and 500A from Ube Industries, Ltd.; and sintered products of the same. Particular preferable nonmagnetic powders are titanium dioxide and α-iron oxide.

Based on the objective, an organic powder may be added to the nonmagnetic layer. Examples are acrylic styrene resin powders, benzoguanamine resin powders, melamine resin powders, and phthalocyanine pigments. Polyolefin resin powders, polyester resin powders, polyamide resin powders, polyimide resin powders, and polyfluoroethylene resins may also be employed. The manufacturing methods described in Japanese Unexamined Patent Publication (KOKAT) Showa Nos. 62-18564 and 60-255827, which are expressly incorporated herein by reference in their entirety, may be employed.

### (Carbon Black)

The magnetic recording medium of the present invention can comprise carbon black in the magnetic layer and/or nonmagnetic layer. Examples of types of carbon black that are suitable for use are: furnace black for rubber, thermal for rubber, black for coloring and acetylene black. A specific surface area of 5 to 500 m²/g, a DBP oil absorption capacity of 10 to 400 ml/100 g, and an average particle size of 5 to 300 nm, preferably 10 to 250 nm, more preferably 20 to 200 nm are respectively desirable. A pH of 2 to 10, a moisture content of 0.1 to 10 percent, and a tap density of 0.1 to 1 g/cc are respectively desirable. Specific examples of types of carbon black employed are: BLACK PEARLS 2000, 1300, 1000, 900, 905, 800, 700 and VULCAN XC-72 from Cabot Corporation; #80, #60, #55, #50 and #35 manufactured by Asahi Carbon Co., Ltd.; #2400B, #2300, #900, #1000, #30, #40 and #10B from Mitsubishi Chemi Corporation; CONDUCTEX SC, RAVEN 150, 50, 40, 15 and RAVEN MT-P from Columbia Carbon Co., Ltd.; and Ketjen Black EC from Lion Akzo Co., Ltd. The carbon black employed may be surface-treated with a dispersant or grafted with resin, or have a partially graphite-treated surface. The carbon black may be dispersed in advance into the binder prior to addition to the coating liquid. These carbon blacks may be used singly or in combination. The quantity of carbon black preferably ranges from 0.1 to 30 weight percent relative to the ferromagnetic powder or nonmagnetic powder, when carbon black is employed. In the magnetic layer, carbon black can work to prevent static, reduce the coefficient of friction (impart smoothness), impart light-blocking properties, enhance film strength, and the like; the properties vary with the type of carbon black employed. Carbon black can be mixed into the nonmagnetic layer to achieve the known effect of reducing surface resistivity Rs and optical transmittance, and achieving a desired micro-Vicker's hardness. A lubricant stockpiling effect can also be achieved by incorporating carbon black into the nonmagnetic layer. Accordingly, based on characteristics required for the magnetic layer and nonmagnetic layer, different types of carbon black can be employed in the magnetic layer and nonmagnetic layer in light of various characteristics such as types, quantities, particle size, oil absorption capacity, electrical conductivity, and pH. The carbon black is preferably optimized for each layer. For example, Carbon Black Handbook compiled by the Carbon Black Association, which is expressly incorporated herein by reference in its entirety, may be consulted for types of carbon black suitable for use in the magnetic layer and/or nonmagnetic layer.

### (Abrasives)

Known materials chiefly having a Mohs' hardness of 6 or greater may be employed either singly or in combination as abrasives in the present invention. These include: α-alumina with an a-conversion rate of equal to or greater than 90 percent, β-alumina, silicon carbide, chromium oxide, cerium oxide, α-iron oxide, corundum, synthetic diamond, silicon nitride, silicon carbide, titanium carbide, titanium oxide, silicon dioxide, and boron nitride. Complexes of these abrasives (obtained by surface treating one abrasive with another) may also be employed. There are cases in which compounds or elements other than the primary compound are contained in these abrasives; the effect does not change so long as the content of the primary compound is equal to or greater than 90 weight percent. The average particle size of the abrasive is preferably 0.01 to 2 micrometers, more preferably 0.05 to 1.0 micrometer, and further preferably, 0.05 to 0.5 micrometer. To enhance electromagnetic characteristics, a narrow particle size distribution is desirable. Abrasives of differing particle size may be incorporated as needed to improve durability; the same effect can be achieved with a single abrasive as with a wide particle size distribution. It is preferable that the tap density is 0.3 to 2 g/cc, the moisture content is 0.1 to 5 percent, the pH is 2 to 11, and the specific surface area is 1 to 30 m²/g. The shape of the abrasive employed in the present invention may be acicular, spherical, cubic, or the like. However, a shape comprising an angular portion is desirable due to high abrasiveness. Specific examples are AKP-12, AKP-15, AKP-20, AKP-30, AKP-50, HIT-20, HIT-30, HIT-55, HIT-60, HIT-70, HIT-80, and HIT-100 made by Sumitomo Chemical Co., Ltd.; ERC-DBM, HP-DBM, and HPS-DBM made by Reynolds Corp.; WA1000 made by Fujimi Abrasive Corp.; UB20 made by Uemura Kogyo Corp.; G-5, Chromex U2, and Chromex UI made by Nippon Chemical Industrial Co., Ltd.; TF10 and TF140 made by Toda Kogyo Corp.; Beta Random Ultrafine made by Ibiden Co., Ltd.; and B-3 made by Showa Kogyo Co., Ltd. Abrasives may be added as needed to the nonmagnetic layer. Addition of abrasives to the nonmagnetic layer can be done to control surface shape, control how the abrasive protrudes, and the like. The particle size and quantity of the abrasives added to the magnetic layer and nonmagnetic layer are preferably set to optimal values.

### (Additives)

Substances having lubricating effects, antistatic effects, dispersive effects, plasticizing effects, or the like may be employed as additives in the magnetic layer and nonmagnetic layer. Examples of additives are: molybdenum disulfide; tungsten disulfide; graphite; boron nitride; graphite fluoride; silicone oils; silicones having a polar group; fatty acid-modified silicones; fluorine-containing silicones; fluorine-containing alcohols; fluorine-containing esters; polyolefins; polyglycols; alkylphosphoric esters and their alkali metal salts; alkylsulfuric esters and their alkali metal salts; polyphenyl ethers; phenylphosphonic acid; α-naphthylphosphoric acid; phenylphosphoric acid; diphenylphosphoric acid; p-ethylbenzenephosphonic acid; phenylphosphinic acid; aminoquinones; various silane coupling agents and titanium coupling agents; fluorine-containing alkylsulfuric acid esters and their alkali metal salts; monobasic fatty acids (which may contain an unsaturated bond or be branched) having 10 to 24 carbon atoms and metal salts (such as Li, Na, K, and Cu) thereof; monohydric, dihydric, trihydric, tetrahydric, pentahydric or hexahydric alcohols with 12 to 22 carbon atoms (which may contain an unsaturated bond or be branched); alkoxy alcohols with 12 to 22 carbon atoms; monofatty esters, difatty esters, or trifatty esters comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 12 carbon atoms (which may contain an unsaturated bond or be branched); fatty acid esters of monoalkyl ethers of alkylene oxide polymers; fatty acid amides with 8 to 22 carbon atoms; and aliphatic amines with 8 to 22 carbon atoms.

Specific examples of the additives in the form of fatty acids are: capric acid, caprylic acid, lauric acid, myristic acid, palmitic acid, stearic acid, behenic acid, oleic acid, claidic acid, linolic acid, linolenic acid, and isostearic acid. Examples of esters are butyl stearate, octyl stearate, amyl stearate, isooctyl stearate, butyl myristate, octyl myristate, butoxyethyl stearate, butoxydiethyl stearate, 2-ethylhexyl stearate, 2-octyldodecyl palmitate, 2-hexyldodecyl palmitate, isohexadecyl stearate, oleyl oleate, dodecyl stearate, tridecyl stearate, oleyl erucate, neopentylglycol didecanoate, and ethylene glycol dioleyl. Examples of alcohols are oleyl alcohol, stearyl alcohol, and lauryl alcohol. It is also possible to employ nonionic surfactants such as alkylene oxide-based surfactants, glycerin-based surfactants, glycidol-based surfactants and alkylphenolethylene oxide adducts; cationic surfactants such as cyclic amines, ester amides, quaternary ammonium salts, hydantoin derivatives, heterocycles, phosphoniums, and sulfoniums; anionic surfactants comprising acid groups, such as carboxylic acid, sulfonic acid, phosphoric acid, sulfuric ester groups, and phosphoric ester groups; and ampholytic surfactants such as amino acids, amino sulfonic acids, sulfuric or phosphoric esters of amino alcohols, and alkyl betaines. Details of these surfactants are described in A Guide to Surfactants (published by Sangyo Tosho K.K.), which is expressly incorporated herein by reference in its entirety. These lubricants, antistatic agents and the like need not be 100 percent pure and may contain impurities, such as isomers, unreacted material, by-products, decomposition products, and oxides in addition to the main components. These impurities are preferably comprised equal to or less than 30 weight percent, and more preferably equal to or less than 10 weight percent.

The lubricants and surfactants suitable for use in the present invention each have different physical effects. The type, quantity, and combination ratio of lubricants producing synergistic effects can be optimally set for a given objective. It is conceivable to control bleeding onto the surface through the use of fatty acids having different melting points in the nonmagnetic layer and the magnetic layer; to control bleeding onto the surface through the use of esters having different boiling points, melting points, and polarity; to improve the stability of coatings by adjusting the quantity of surfactant; and to increase the lubricating effect by increasing the amount of lubricant in the intermediate layer. The present invention is not limited to these examples. In general, the total amount of lubricant can be 0.1 to 50 weight percent, and preferably 2 to 25 weight percent with respect to the ferromagnetic powder or nonmagnetic powder.

Known organic solvents can be used. Examples of the organic solvents are ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol, and methylcyclohexanol; esters such as methyl acetate, butyl acetate, isobutyl acetate, isopropyl acetate, ethyl lactate, and glycol acetate; glycol ethers such as glycol dimethyl ether, glycol monoethyl ether, and dioxane; aromatic hydrocarbons such as benzene, toluene, xylene, cresol, and chlorobenzene; chlorinated hydrocarbons such as methylene chloride, ethylene chloride, carbon tetrachloride, chloroform, ethylene chlorohydrin, and dichlorobenzene; N,N-dimethylformamide; and hexane; these may be employed in any ratio.

### (Surface-Modifying Agent)

A compound containing at least one carboxyl group and/or hydroxyl group per molecule can be employed as an additive in the magnetic layer. Dispersibility of ferromagnetic powder can be enhanced by preventing aggregation of the ferromagnetic powder. The above compound can function as a so-called “surface-modifying agent” because it can highly adsorb to the magnetic material and thus modify the surface of the magnetic material to improve dispersibility of the magnetic material.

The above compound may comprise just one from among a carboxyl group and a hydroxyl group, or may comprise both. The number of the above substituents per molecule of the compound is at least 1, desirably 1 to 5, and preferably, 1 to 3.

The compound (so-called “surface-modifying agent”) may be either a cyclic compound or a chain compound so long as it comprises at least one carboxyl group and/or hydroxyl group per molecule. A cyclic compound is preferred.

The ring structure of the cyclic compound may be that of an aliphatic ring, aromatic ring, or hetero ring. That is, an example of the cyclic compound is at least one member selected from the group consisting of aliphatic compounds, aromatic compounds, and heterocyclic compounds. The ring structure may be that of a single ring or condensed rings. One or more types of ring structure may be contained per molecule, and the structure may be one in which different types of ring structures are linked by a linking group. Suitable examples of the ring structure contained in the cyclic compound are at least one member selected from the group consisting of a cyclohexane ring, a benzene ring, a pyridine ring, and a naphthalene ring.

When the cyclic compound is an alicyclic compound, the ring structure contained is, for example, an optionally condensed aliphatic ring having 5 to 30 carbon atoms, desirably an optionally condensed aliphatic ring having 5 to 10 carbon atoms, and preferably a cyclohexane ring.

When the cyclic compound is an aromatic compound, the aromatic ring contained is desirably a five-membered ring, six-membered ring, seven membered ring, or a condensed ring thereof. A five-membered ring or a six-membered ring is preferred, and a six-membered ring is of greater preference. Specific examples are a benzene ring, naphthalene ring, anthracene ring, and phenanthrene ring. Of these, a benzene ring and a naphthalene ring are desirable.

When the cyclic compound is a heterocyclic compound, examples of the hetero atoms contained in the hetero ring are nitrogen, oxygen, and sulfur atoms. Nitrogen atoms are desirable. The hetero ring has, for example, 1 to 30 carbon atoms, desirably 1 to 20 carbon atoms, and preferably, 1 to 12 carbon atoms. Specific examples of the hetero ring are a pyrrole ring, pyrazole ring, imidazole ring, pyridine ring, furan ring, thiophene ring, oxazole ring, thiazole ring, benzo-condensed rings of the same, and hetero-condensed rings of the same. A pyridine ring is desirable as the hetero ring.

The cyclic compound may comprise one or more substituents in addition to carboxyl and hydroxyl groups. Examples of these substituents are halogen atoms (fluorine, chlorine, bromine, and iodine atoms), cyano groups, nitro groups, alkyl groups with 1 to 16 carbon atoms, alkenyl groups with 1 to 16 carbon atoms, alkynyl groups with 2 to 16 carbon atoms, alkyl groups substituted with halogen atoms and having 1 to 16 carbon atoms, alkoxy groups having 1 to 16 carbon atoms, acyl groups having 2 to 16 carbon atoms, alkylthio groups having 1 to 16 carbon atoms, acyloxy groups having 2 to 16 carbon atoms, alkoxycarbonyl groups having 2 to 16 carbon atoms, carbamoyl groups, carbamoyl groups substituted with alkyl groups having 2 to 16 carbon atoms, and acylamino groups having 2 to 16 carbon atoms. The substituents are desirably halogen atoms, cyano groups, alkyl groups having 1 to 6 carbon atoms, and alkyl groups having 1 to 6 carbon atoms and substituted with halogen atoms. Halogen atoms, alkyl groups having 1 to 4 carbon atoms, and alkyl groups having 1 to 4 carbon atoms and substituted with halogen atoms are preferred. Halogen atoms, alkyl groups having 1 to 3 carbon atoms, and trifluoromethyl groups are of greater preference.

Desirable specific examples of the cyclic compound are 1-naphthoic acid, catechol, phenol, phthalic acid, 4-tert-butylphenol, 4-tert-butylbenzoic acid, 4-butylphenol, 4-hydroxypyridine, and cyclohexanecarboxylic acid. Catechol and 1 -naphthoic acid are preferred and 1-naphthoic acid is of greater preference.

The above compounds can be readily synthesized by known methods, and in some cases are available as commercial products.

The content of the above compound in the magnetic layer can be suitably established. It is desirably 0.1 to 10 weight parts, preferably 0.5 to 10 weight parts, and more preferably, 1 to 8 weight parts per 100 weight parts of ferromagnetic powder. Keeping the content of the above compound at or below the upper limit of the above-described range can inhibit plasticization of the film and suppress peeling of the film. Additionally, keeping the content of the above compound at or above the lower limit of the above-described range can further inhibit head grime.

All or a portion of the additives employed in the present invention can be added during any step in the manufacturing of a magnetic layer coating liquid and nonmagnetic layer coating liquid. For example, there are times when they are mixed with the ferromagnetic powder before the kneading step, times when they are added with the ferromagnetic powder, binder and solvent in the kneading step, times when they are added during the dispersing step, times when they are added after the dispersing step, and times when they are added immediately prior to coating. Based on the objective, there are times when an objective is achieved by coating all or part of the additives in simultaneous or successive coatings after coating the magnetic layer. Based on the objective, there are times when a lubricant is coated to the magnetic layer surface after calendering or slitting has been completed. Known organic solvents can be employed in the present invention. For example, the solvents described in Japanese Unexamined Patent Publication (KOKAI) Showa No. 6-68453, which is expressly incorporated herein by reference in its entirety, can be employed.

### (Layer Structure)

In the magnetic recording medium of the present invention, the thickness of the nonmagnetic support ranges from, for example, 2 to 100 micrometers, preferably from 2 to 80 micrometers. For computer-use magnetic recording tapes, the nonmagnetic support having a thickness of 3.0 to 6.5 micrometers, preferably 3.0 to 6.0 micrometers, more preferably 4.0 to 5.5 micrometers is suitably employed.

An undercoating layer may be provided to improve adhesion between the nonmagnetic support and the nonmagnetic layer or magnetic layer. The thickness of the undercoating layer can be made from 0.01 to 0.5 micrometer, preferably from 0.02 to 0.5 micrometer. The magnetic recording medium of the present invention may be a disk-shaped medium in which a nonmagnetic layer and magnetic layer are provided on both sides of the nonmagnetic support, or may be a tape-shaped or disk-shaped magnetic recording medium having these layers on just one side. In the latter case, a backcoat layer may be provided on the opposite surface of the nonmagnetic support from the surface on which is provided the magnetic layer to achieve effects such as preventing static and compensating for curl. The thickness of the backcoat layer is, for example, from 0.1 to 4 micrometers, preferably from 0.3 to 2.0 micrometers. Known undercoating layers and backcoat layers may be employed.

The thickness of the nonmagnetic layer is normally 0.2 to 5.0 micrometers, preferably 0.3 to 3.0 micrometers, and further preferably, 0.4 to 2.0 micrometers.

The thickness of the magnetic layer can be optimized based on the saturation magnetization of the head employed, the length of the head gap, and the recording signal band, and is preferably 30 to 150 nm, more preferably 50 to 120 nm, and further preferably, 60 to 100 nm. The thickness variation in the magnetic layer is preferably within ±50 percent, more preferably within ±30 percent. At least one magnetic layer is sufficient. The magnetic layer may be divided into two or more layers having different magnetic characteristics, and a known configuration relating to multilayered magnetic layer may be applied.

### (Backcoat Layer)

Generally, stronger repeat running properties are demanded of magnetic recording media (magnetic tapes) for use in recording computer data than of audio and video tapes. To maintain such high running durability, carbon black and inorganic powder are desirably incorporated into a backcoat layer.

An example of an inorganic powder that can be added to the backcoat layer is an inorganic powder with a Mohs' hardness of 5 to 9 and an average particle size of 80 to 250 nm. Examples of inorganic powders that can be employed are α-iron oxide, α-alumina, chromium oxide (Cr₂O₃), and TiO₂. Of these, the use of α-iron oxide and α-alumina is desirable.

The carbon blacks that are commonly employed in magnetic recording media can be widely employed in the backcoat layer. For example, furnace black for rubber, thermal for rubber, black for coloring and acetylene black can be employed. To prevent the transfer of backcoat layer nonuniformities to the magnetic layer, the average particle size of the carbon black is desirably equal to or lower than 0.3 micrometer, preferably 0.01 to 0.1 micrometer. The quantity of carbon black employed in the backcoat layer is desirably such that the optical transmission density (the transmission level of a TR-927 made by Macbeth) falls within a range of equal to or lower than 2.0.

The use of two carbon blacks of differing average particle size is advantageous to improve running durability. In that case, the combination of a first carbon black having an average particle size falling within a range of 0.01 to 0.04 micrometer and a second carbon black having an average particle size falling within a range of 0.05 to 0.3 micrometer is desirable. The quantity of the second carbon black is suitably 0.1 to 10 weight parts, desirably 0.3 to 3 weigh parts, per 100 weight parts of the inorganic powder and the first carbon black combined. The quantity of binder employed can be selected within a range of 10 to 40 weight parts, preferably 20 to 32 weight parts, per 100 weight parts of the inorganic powder and carbon black combined. Conventionally known thermoplastic resins, thermosetting resins, reactive resins, and the like can be employed as the binder in the backcoat layer.

### (Nonmagnetic Support)

Known films of the following may be employed as the nonmagnetic support: polyethylene terephthalate, polyethylene naphthalate, other polyesters, polyolefins, cellulose triacetate, polycarbonate, polyamides, polyimides, polyamidoimides, polysulfones, aromatic polyamides, polybenzooxazoles, and the like. Supports having a glass transition temperature of equal to or higher than 100° C. are preferably employed. The use of polyethylene naphthalate, aramid, or some other high-strength support is particularly desirable. As needed, layered supports such as disclosed in Japanese Unexamined Patent Publication (KOKAI) Heisei No. 3-224127, which is expressly incorporated herein by reference in its entirety, may be employed to vary the surface roughness of the magnetic surface and support surface. These supports may be subjected beforehand to corona discharge treatment, plasma treatment, adhesion enhancing treatment, heat treatment, dust removal, and the like.

The center surface average surface roughness (Ra) of the nonmagnetic support as measured with an optical interferotype surface roughness meter HD-2000 made by WYKO is preferably equal to or less than 8.0 nm, more preferably equal to or less than 4.0 nm, further preferably equal to or less than 2.0 nm. Not only does such a support desirably have a low center surface average surface roughness (Ra), but there are also desirably no large protrusions equal to or higher than 0.5 μm. The surface roughness shape may be freely controlled through the size and quantity of filler added to the support as needed. Examples of such fillers are oxides and carbonates of elements such as Ca, Si, and Ti, and organic powders such as acrylic-based one. The support desirably has a maximum height Rₘₐₓ equal to or less than 1 μm, a ten-point average roughness R_{Z} equal to or less than 0.5 μm, a center surface peak height R_{P} equal to or less than 0.5 μm, a center surface valley depth R_{V} equal to or less than 0.5 μm, a center-surface surface area percentage Sr of 10 percent to 90 percent, and an average wavelength λₐ of 5 to 300 μm. To achieve desired electromagnetic characteristics and durability, the surface protrusion distribution of the support can be freely controlled with fillers. It is possible to control within a range from 0 to 2,000 protrusions of 0.01 to 1 μm in size per 0.1 mm².

The F-5 value of the nomnagnetic support suitable for use in the present invention desirably ranges from 5 to 50 kg/mm², approximately 49 to 490 MPa. The thermal shrinkage rate of the support after 30 min at 100° C. is preferably equal to or less than 3 percent, more preferably equal to or less than 1.5 percent. The thermal shrinkage rate after 30 min at 80° C. is preferably equal to or less than 1 percent, more preferably equal to or less than 0.5 percent. The breaking strength of the nonmagnetic support preferably ranges from 5 to 100 kg/mm², approximately 49 to 980 MPa. The modulus of elasticity preferably ranges from 100 to 2,000 kg/mm², approximately 0.98 to 19.6 GPa. The thermal expansion coefficient preferably ranges from 10⁻⁴ to 10⁻⁸/° C., more preferably from 10⁻⁵ to 10⁻⁶/° C. The moisture expansion coefficient is preferably equal to or less than 10⁻⁴/RH percent, more preferably equal to or less than 10⁻⁵/RH percent. These thermal characteristics, dimensional characteristics, and mechanical strength characteristics are desirably nearly equal, with a difference equal to less than 10 percent, in all in-plane directions in the support.

### (Preparation of Coating Liquid)

The process for manufacturing coating liquids for magnetic and nomnagnetic layers can comprise at least a kneading step, a dispersing step, and a mixing step to be carried out, if necessary, before and/or after the kneading and dispersing steps. Each of the individual steps may be divided into two or more stages. All of the starting materials employed in the present invention, including the ferromagnetic powder, nonmagnetic powder, binders, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. When a kneader is employed, the ferromagnetic powder or nonmagnetic powder and all or part of the binder (preferably equal to or higher than 30 weight percent of the entire quantity of binder) can be kneaded in a range of 15 to 500 parts per 100 parts of the ferromagnetic powder. Details of the kneading process are described in Japanese Unexamined Patent Publication (KOKAI) Heisei Nos. 1-106338 and 1-79274, which are expressly incorporated herein by reference in their entirety. Further, glass beads may be employed to disperse the coating liquids for magnetic and nonmagnetic layers, with a dispersing medium with a high specific gravity such as zirconia beads, titania beads, and steel beads being suitable for use. The particle diameter and fill ratio of these dispersing media can be optimized for use. A known dispersing device may be employed.

In the method of manufacturing a magnetic recording medium, for example, a magnetic layer can be formed by coating a magnetic layer coating liquid to a prescribed thickness on the surface of a nonmagnetic support that is being run. Multiple magnetic layer coating liquids can be successively or simultaneously coated in a multilayer coating, or a nonmagnetic layer coating liquid and a magnetic layer coating liquid can be successively or simultaneously coated in a multilayer coating. A successive multilayer coating (wet-on-dry) is desirable from the perspective of suppressing boundary variation between the magnetic layer and nonmagnetic layer. Coating machines suitable for use in coating the magnetic layer or nonmagnetic layer coating liquid are air doctor coaters, blade coaters, rod coaters, extrusion coaters, air knife coaters, squeeze coaters, immersion coaters, reverse roll coaters, transfer roll coaters, gravure coaters, kiss coaters, cast coaters, spray coaters, spin coaters, and the like. For example, “Recent Coating Techniques” (May 31, 1983), issued by the Sogo Gijutsu Center K.K. may be referred to in this regard. The content of the above publication is expressly incorporated herein by reference in its entirety.

For a magnetic tape, the coating layer that is formed by applying the magnetic layer coating liquid can be magnetic field orientation processed using cobalt magnets or solenoids on the ferromagnetic powder contained in the coating layer. In the case of a disk, adequately isotropic orientation can sometimes be achieved with no orientation without using an orienting device. However, the diagonal arrangement of cobalt magnets in alternating fashion or the use of a known random orienting device such as a solenoid to apply an a.c. magnetic field is desirable. In the case of a ferromagnetic metal powder, the term “isotropic orientation” generally means randomness in the two in-plane dimensions, but can also be three-dimensional randomness when the vertical component is included. A known method such as magnets with opposite poles positioned opposite each other can also be employed to impart isotropic magnetic characteristics in a circumferential direction by effecting vertical orientation. When conducting particularly high-density recording, vertical orientation is desirable. Spin coating can also be employed to effect circumferential orientation.

The drying position of the coating is desirably controlled by controlling the temperature and flow rate of drying air, and coating speed. A coating speed of 20 m/min to 1,000 m/min and a dry air temperature of equal to or higher than 60° C. are desirable. Suitable predrying can be conducted prior to entry into the magnet zone.

The coated stock material obtained in this manner is normally temporarily rolled on a pickup roll, and after a period, wound off the pickup roll and subjected to calendering.

In calendering, super calender rolls or the like can be employed. Calendering can enhance the smoothness of the surface, eliminate voids produced by removing the solvent during drying, and increase the fill rate of ferromagnetic powder in the magnetic layer, yielding a magnetic recording medium with good electromagnetic characteristics. The calendering step is desirably conducted by varying the calendering conditions based on the smoothness of the surface of the coated stock material.

The surface smoothness of the coated stock material can be controlled by means of the calender roll temperature, calender roll speed, and calender roll tension. The calender roll pressure and calender roll temperature are desirably controlled by taking into account the characteristics of the particulate medium. Lowering the calender roll pressure or calender roll temperature can decrease the surface smoothness of the final product. Conversely, raising the calender roll pressure or calender roll temperature can increase the surface smoothness of the final product.

Additionally, following the calendering step, the magnetic recording medium can be thermally processed to cause thermosetting to proceed. Such thermal processing can be suitably determined based on the blending formula of the magnetic layer coating liquid. An example is 35 to 100° C., desirably 50 to 80° C. The thermal processing period is, for example, 12 to 72 hours, desirably 24 to 48 hours.

Calender rolls made of epoxy, polyimide, polyamide, polyamideimide, and other heat-resistant plastic rolls can be employed. Processing can also be conducted with metal rolls.

Among the calendering conditions, the calender roll temperature, for example, falls within a range of 60 to 100° C., desirably a range of 70 to 100° C., and preferably a range of 80 to 100° C. The pressure, for example, falls within a range of 100 to 500 kg/cm (approximately 98 to 490 kN/m), preferably a range of 200 to 450 kg/cm (approximately 196 to 441 kN/m), and preferably a range of 300 to 400 kg/cm (approximately 294 to 392 kN/m). To increase the smoothness of the magnetic layer surface, the nonmagnetic layer surface can also be calendered. Calendering of the nonmagnetic layer is also desirably conducted under the above conditions.

The magnetic recording medium that is obtained can be cut to desired size with a cutter or the like for use. The cutter is not specifically limited, but desirably comprises multiple sets of a rotating upper blade (male blade) and lower blade (female blade). The slitting speed, engaging depth, peripheral speed ratio of the upper blade (male blade) and lower blade (female blade) (upper blade peripheral speed/lower blade peripheral speed), period of continuous use of slitting blade, and the like can be suitably selected.

### Physical Characteristics

Extremely good surface smoothness can be achieved in the magnetic recording medium of the present invention by incorporating the above polyurethane resin as a constituent component of the binder. The surface smoothness of the magnetic recording medium of the present invention desirably falls within a range of 0.1 to 4 nm, preferably 1 to 3 nm, as the center surface average roughness of the magnetic layer surface. The ten-point average roughness R_{Z} on the surface of the magnetic layer is desirably equal to or less than 30 nm. The surface properties of the magnetic layer can be controlled by means of fillers added to the support, the surface shape of calender rolls, and the like. Curling is preferably controlled to within ±3 mm.

The saturation magnetic flux density of the magnetic layer preferably ranges from 100 to 400 mT. The coercivity (Hc) of the magnetic layer is preferably 143.2 to 318.3 kA/m (approximately 1,800 to 4,000 Oe), more preferably 159.2 to 278.5 kA/m (approximately 2,000 to 3,500 Oe). Narrower coercivity distribution is preferable. The SFD and SFDr are preferably equal to or lower than 0.6, more preferably equal to or lower than 0.3.

The coefficient of friction of the magnetic recording medium of the present invention relative to the head is, for example, equal to or less than 0.50 and preferably equal to or less than 0.3 at temperatures ranging from −10° C. to 40° C. and humidity ranging from 0 percent to 95 percent, the surface resistivity on the magnetic surface preferably ranges from 10⁴ to 10⁸ ohm/sq, and the charge potential preferably ranges from −500 V to +500 V. The modulus of elasticity at 0.5 percent extension of the magnetic layer preferably ranges from 0.98 to 19.6 GPa (approximately 100 to 2,000 kg/mm²) in each in-plane direction. The breaking strength preferably ranges from 98 to 686 MPa (approximately 10 to 70 kg/m²). The modulus of elasticity of the magnetic recording medium preferably ranges from 0.98 to 14.7 GPa (approximately 100 to 1500 kg/mm²) in each in-plane direction. The residual elongation is preferably equal to or less than 0.5 percent, and the thermal shrinkage rate at all temperatures below 100° C. is preferably equal to or less than 1 percent, more preferably equal to or less than 0.5 percent, and most preferably equal to or less than 0.1 percent.

The glass transition temperature (i.e., the temperature at which the loss elastic modulus of dynamic viscoelasticity peaks as measured at 110 Hz) of the magnetic layer preferably ranges from 50 to 180° C., and that of the nonmagnetic layer preferably ranges from 0 to 180° C. The loss elastic modulus preferably falls within a range of 1×10⁷ to 8×10⁸ Pa (approximately 1×10⁸ to 8×10⁹ dyne/cm²) and the loss tangent is preferably equal to or less than 0.2. Adhesion failure tends to occur when the loss tangent becomes excessively large. These thermal characteristics and mechanical characteristics are desirably nearly identical, varying by equal to or less than 10 percent, in each in-plane direction of the medium.

The residual solvent contained in the magnetic layer is preferably equal to or less than 100 mg/m² and more preferably equal to or less than 10 mg/m². The void ratio in the coated layers, including both the nonmagnetic layer and the magnetic layer, is preferably equal to or less than 30 volume percent, more preferably equal to or less than 20 volume percent. Although a low void ratio is preferable for attaining high output, there are some cases in which it is better to ensure a certain level based on the object. For example, in many cases, larger void ratio permits preferred running durability in disk media in which repeat use is important.

When the magnetic recording medium of the present invention comprises both a magnetic layer and a nonmagnetic layer, physical properties of the nonmagnetic layer and magnetic layer may be varied based on the objective. For example, the modulus of elasticity of the magnetic layer may be increased to improve running durability while simultaneously employing a lower modulus of elasticity than that of the magnetic layer in the nonmagnetic layer to improve the head contact of the magnetic recording medium.

### Binder for Magnetic Recording Medium

An aspect of the present invention relates to a binder for a magnetic recording medium, comprising a constituent component in the form of a polyurethane resin obtained from starting materials in the form of a polyisocyanate and a polyol denoted by the above general formula (I). The binder for a magnetic recording medium of the present invention can be employed as a binder for a nonmagnetic layer and/or a magnetic layer. Details thereof are as set forth above.

### Polyurethane Resin

A further aspect of the present invention relates to a polyurethane resin, obtained from starting materials in the form of a polyisocyanate and a polyol denoted by the above general formula (I). The polyurethane resin of the present invention is suitable for use as a binder in magnetic recording media. Details thereof are as set forth above.

### EXAMPLES

The present invention will be described in detail below based on Examples. However, the present invention is not limited to the examples. The “parts” given in Examples are weight parts unless specifically stated otherwise.

### Example 1

### Synthesis of Lactone Ring-Containing Polyurethane Resin (1)

To 50.5 weight parts of cyclohexanone were added 1.0 weight part of D-erythronolactone, 10.3 weight parts of polyether (Adeka polyether BPX-1000, made by ADEKA Corporation), 5.0 weight parts of tricyclo[5,2,1,0(2,6)]decanedimethanol (made by Tokyo Chemical Industry Co., Ltd.), and 0.01 weight part of dibutyltin dilaurate and the mixture was fully dissolved by stirring for 30 minutes at room temperature. The moisture in the flask was measured with a Karl Fischer moisture meter, and diphenylmethane diisocyanate (Millionate MT made by Nippon Polyurethane Industry Co., Ltd.) was added in a molar quantity equal to that of the water content. The internal temperature was adjusted to 80° C., after which 18.6 weight parts of cyclohexanone containing 50 weight percent of diphenylmethane diisocyanate (Millionate MT made by Nippon Polyurethane Industry Co., Ltd.) were added dropwise at a rate resulting in an internal temperature of 80 to 90° C. The mixture was stirred for 4 hours at an internal temperature of 80 to 90° C. and then cooled to room temperature.

The weight average molecular weight and the ratio of the weight average molecular weight to the number average molecular weight (Mw/Mn) of the polyurethane obtained were calculated by standard polystyrene conversion using DMF solution containing 0.3 weight percent of lithium bromide. The weight average molecular weight was 70,000 and the Mw/Mn=1.90.

The polyurethane obtained was concentrated to solid, dissolved with D-erythronolactone in deuterated DMSO, and analyzed by ¹H-NMR to confirm that the lactone rings had been retained in the polyurethane.

Polyurethane (deuterated DMSO) δ (ppm)=4.05 (1H, d), 4.34-4.23 (2H, m), 4.42-4.37 (1H, m)

D-erythronolactone (deuterated DMSO) δ (ppm)=4.05 (1H, d), 4.23 (1H, m), 4.27 (1H, dd), 4.38 (1H, d)

Based on the facts that (1) GPC analysis conducted following the reaction revealed no residual monomer or residual oligomer peaks; and (2) a lactone skeleton was confirmed in the ¹H-NMR spectra of the reaction product obtained by reacting just lactone diol and diphenylmethane diisocyanate, it was determined that the quantity of lactone ring units charged had been fully incorporated while retaining the ring structure. Table 1 shows the lactone ring content calculated based on the quantity charged. For polyurethane resin synthesized using diol that contained sulfonic acid salt groups, described further below, it can be confirmed based on the results of (1) above that the introduction was effected without the presence of residual diol that contained sulfonic acid salt groups. Table 1 shows the sulfonic acid salt group content of the polyurethane resin calculated based on the quantity charged. Based on measurement of the sulfur content of the polyurethane resin by X-ray fluorescence analysis, the sulfonic acid group content in the polyurethane was confirmed to be the value given in Table 1.

### Example 2

### Synthesis of Lactone Ring-Containing Polyurethane Resin (2)

To 166.6 weight parts of cyclohexanone were added 1.0 weight part of D-erythronolactone, 31.0 weight parts of polyether (Adeka polyether BPX-1000, made by ADEKA Corporation), 22.0 weight parts of tricyclo[5,2,1,0(2,6)]decanedimethanol (made by Tokyo Chemical Industry Co., Ltd.), and 0.01 weight part of dibutyltin dilaurate and the mixture was fully dissolved by stirring for 30 minutes at room temperature. The moisture in the flask was measured with a Karl Fischer moisture meter, and diphenylmethane diisocyanate (Millionate MT made by Nippon Polyurethane Industry Co., Ltd.) was added in a molar quantity equal to that of the water content. The internal temperature was adjusted to 80° C., after which 61.5 weight parts of cyclohexanone containing 50 weight percent of diphenylmethane diisocyanate (Millionate MT made by Nippon Polyurethane Industry Co., Ltd.) were added dropwise at a rate resulting in an internal temperature of 80 to 90° C. The mixture was stirred for 4 hours at an internal temperature of 80 to 90° C. and then cooled to room temperature.

The weight average molecular weight and the ratio of the weight average molecular weight to the number average molecular weight (Mw/Mn) of the polyurethane obtained were calculated by standard polystyrene conversion using DMF solution containing 0.3 weight percent of lithium bromide. The weight average molecular weight was 70,000 and the Mw/Mn=1.90.

### Example 3

### Synthesis of Lactone Ring-Containing Polyurethane Resin (3)

To 9.1 weight parts of cyclohexanone were added 1.0 weight part of dipalnitoyl ascorbic acid, 0.79 weight part of polyether (Adeka polyether BPX-1000, made by ADEKA Corporation), 1.16 weight parts of tricyclo[5,2,1,0(2,6)]decanedimethanol (made by Tokyo Chemical Industry Co., Ltd.), and 0.01 weight part of dibutyltin dilaurate and the mixture was fully dissolved by stirring for 30 minutes at room temperature. The moisture in the flask was measured with a Karl Fischer moisture meter, and diphenylmethane diisocyanate (Millionate MT made by Nippon Polyurethane Industry Co., Ltd.) was added in a molar quantity equal to that of the water content. The internal temperature was adjusted to 80° C., after which 3.4 weight parts of cyclohexanone containing 50 weight percent of diphenylmethane diisocyanate (Millionate MT made by Nippon Polyurethane Industry Co., Ltd.) were added dropwise at a rate resulting in an internal temperature of 80 to 90° C. The mixture was stirred for 4 hours at an internal temperature of 80 to 90° C. and then cooled to room temperature.

The weight average molecular weight and the ratio of the weight average molecular weight to the number average molecular weight (Mw/Mn) of the polyurethane obtained were calculated by standard polystyrene conversion using DMF solution containing 0.3 weight percent of lithium bromide. The weight average molecular weight was 70,000 and the Mw/Mn=1.90.

### Example 4

### Synthesis of Lactone Ring-Containing Polyurethane Resin (4)

To 9.1 weight parts of cyclohexanone were added 1.0 weight part of dipalmitoyl ascorbic acid, 0.63 weight part of polyether (Adeka polyether BPX-1000, made by ADEKA Corporation), 0.76 weight part of tricyclo[5,2,1,0(2,6)]decanedimethanol (made by Tokyo Chemical Industry Co., Ltd.), 0.57 weight part of the sulfonic acid salt group-containing diol (a) indicated below, and 0.01 weight part of dibutyltin dilaurate and the mixture was fully dissolved by stirring for 30 minutes at room temperature. The moisture in the flask was measured with a Karl Fischer moisture meter, and diphenylmethane diisocyanate (Millionate MT made by Nippon Polyurethane Industry Co., Ltd.) was added in a molar quantity equal to that of the water content. The internal temperature was adjusted to 80° C., after which 3.4 weight parts of cyclohexanone containing 50 weight percent of diphenylmethane diisocyanate (Millionate MT made by Nippon Polyurethane Industry Co., Ltd.) were added dropwise at a rate resulting in an internal temperature of 80 to 90° C. The mixture was stirred for 4 hours at an internal temperature of 80 to 90° C. and then cooled to room temperature.

The weight average molecular weight and the ratio of the weight average molecular weight to the number average molecular weight (Mw/Mn) of the polyurethane obtained were calculated by standard polystyrene conversion using DMF solution containing 0.3 weight percent of lithium bromide. The weight average molecular weight was 70,000 and the Mw/Mn=1.90.

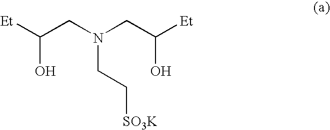

### Example 5

### Synthesis of Lactone Ring-Containing Polyurethane Resin (5)

To 9.13 weight parts of cyclohexanone were added 1.0 weight part of dipalmitoyl ascorbic acid, 0.34 weight part of polyether (Adeka polyether BPX-1000, made by ADEKA Corporation), 0.83 weight part of tricyclo[5,2,1,0(2,6)]decanedimethanol (made by Tokyo Chemical Industry Co., Ltd.), 0.79 weight part of the sulfonic acid salt group-containing diol (b) indicated below, and 0.01 weight part of dibutyltin dilaurate and the mixture was fully dissolved by stirring for 30 minutes at room temperature. The moisture in the flask was measured with a Karl Fischer moisture meter, and diphenylmethane diisocyanate (Millionate MT made by Nippon Polyurethane Industry Co., Ltd.) was added in a molar quantity equal to that of the water content. The internal temperature was adjusted to 80° C, after which 3.4 weight parts of cyclohexanone containing 50 weight percent of diphenylmethane diisocyanate (Millionate MT made by Nippon Polyurethane Industry Co., Ltd.) were added dropwise at a rate resulting in an internal temperature of 80 to 90° C. The mixture was stirred for 4 hours at an internal temperature of 80 to 90° C. and then cooled to room temperature.

The weight average molecular weight and the ratio of the weight average molecular weight to the number average molecular weight (Mw/Mn) of the polyurethane obtained were calculated by standard polystyrene conversion using DMF solution containing 0.3 weight percent of lithium bromide. The weight average molecular weight was 70,000 and the Mw/Mn=1.90.

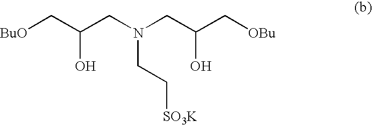

### Comparative Example 1

### Manufacturing of Magnetic Recording Medium

Magnetic Layer Coating Liquid

| | | |
|---|---|---|
| Magnetic material) Hexagonal barium ferrite powder | 100 | parts |
| Composition other than oxygen (molar ratio): | | |
| Ba/Fe/Co/Zn = 1/9/0.2/1 | | |
| Hc: 176 kA/m (approximately 2200 Oe) | | |
| Average plate diameter: 30 nm | | |
| Average plate ratio: 3 | | |
| Specific surface area by BET method: 65 m²/g | | |
| σs: 49 A · m²/kg (approximately 49 emu/g) | | |
| pH: 7 | | |
| Binder) Polyurethane resin based on branched side | 14 | parts |
| chain-containing polyester polyol/diphenylmethane | | |
| diisocyanate, containing 0.33 meq/g of —SO₃Na group | | |
| α-alumina (particle size: 0.15 μm) | 5 | parts |
| Diamond powder (average particle diameter: 60 nm) | 1 | part |
| Carbon black (average particle diameter: 20 nm) | 1 | part |
| Cyclohexanone | 110 | parts |
| Methyl ethyl ketone | 100 | parts |
| Toluene | 100 | part |
| Butyl stearate | 2 | parts |
| Stearic acid | 1 | part |

Nonmagnetic Layer Coating Liquid

| | | |
|---|---|---|
| Nonmagnetic inorganic powder: α-iron oxide | 85 | parts |
| Surface-treatment coating layer: Al₂O₃, SiO₂ | | |
| Average major axis length: 0.15 μm | | |
| Average acicular ratio: 7 | | |
| Specific surface area by BET method: 52 m²/g | | |
| pH: 8 | | |
| Carbon black | 15 | parts |
| Vinyl chloride copolymer (MR110 made by Nippon Zeon | 10 | parts |
| Co., Ltd.) | | |
| Polyurethane resin based on branched side chain-containing | 10 | parts |
| polyester polyol/diphenylmethane diisocyanate, containing | | |
| 0.2 meq/g of —SO₃Na group | | |
| Phenylphosphonic acid | 3 | parts |
| Cyclohexanone | 140 | parts |
| Methyl ethyl ketone | 170 | parts |
| Butyl stearate | 2 | parts |
| Stearic acid | 1 | part |

Backcoat Layer Coating Liquid

| | | |
|---|---|---|
| Microparticulate carbon black | 100 | parts |
| (BPr800 made by Cabot Corporation, average particle size: | | |
| 17 nm) | | |
| Coarse particulate carbon black | 10 | parts |
| (Thermal black made by Cancarb Limited., average | | |
| particle size: 270 nm) | | |
| α-alumina (hard inorganic powder) | 2 | parts |
| (Average particle size: 200 nm, Mohs' hardness: 9) | | |
| Nitrocellulose resin | 140 | parts |
| Polyurethane resin | 15 | parts |
| Polyester resin | 5 | parts |
| Dispersing agent: | | |
| Copper oleate | 5 | parts |
| Barium sulfate | 5 | parts |
| (BF-1 made by Sakai Chemical Industry Co., Ltd., average | | |
| particle diameter: 50 nm, Mohs' hardness: 3) | | |
| Methyl ethyl ketone | 1200 | parts |
| Butyl acetate | 300 | parts |
| Toluene | 600 | parts |

The above nonmagnetic layer coating liquid was processed as follows. The various components were kneaded in an open kneader and dispersed using a sand mill. To the dispersion obtained were added 5 parts of polyisocyanate (Coronate L made by Nippon Polyurethane Industry Co., Ltd.), followed by 40 parts of a mixed solvent of methyl ethyl ketone and cyclohexanone. The mixture was mixed, stirred, and filtered with a filter having a pore diameter of 1 micrometer to prepare a nonmagnetic layer coating liquid.

The magnetic layer coating liquid was processed as follows. Hexagonal ferrite powder and 1-naphthoic acid were dispersed for 15 minutes in dry form. The dispersion was kneaded with the above magnetic layer components in an open kneader and then dispersed using a sand mill. To the dispersion obtained were added 2.5 parts of polyisocyanate (Coronate L made by Nippon Polyurethane Industry Co., Ltd.) followed by 40 parts of a mixed solvent of methyl ethyl ketone and cyclohexanone. The mixture was mixed, stirred, and filtered with a filter having a pore diameter of 1 micrometer to prepare a magnetic layer coating liquid.

The backcoat layer coating liquid was processed as follows. The above components were kneaded in a continuous kneader and then dispersed using a sand mill. To the dispersion obtained were added 40 parts of polyisocyanate (Coronate L made by Nippon Polyurethane Industry Co., Ltd.) followed by 1,000 parts of methyl ethyl ketone. The mixture was stirred and filtered with a filter having a pore diameter of 1 micrometer.

The nonmagnetic layer coating liquid and magnetic layer coating liquid obtained were simultaneously coated in a multilayer coating and dried on a support (biaxially oriented polyethylene terephthalate) 7 micrometers in thickness in a manner calculated to yield a nonmagnetic layer with a dry film thickness of 1.5 micrometers, a magnetic layer with a dry film thickness of 0.10 micrometer, and a tape with a total dry thickness of 8.6 micrometers. Subsequently, a backcoat layer was coated to the opposite surface from the magnetic layer in a manner calculated to yield a dry thickness of 0.5 micrometer.

Calendering was then conducted with a seven-stage calender comprised only of metal rolls at a rate of 100 m/min, a linear pressure of 350 kg/cm (343 kN/m), and a temperature of 80° C. The roll obtained was heat treated at 50° C. for 48 hours. It was then slit to a width of ½ inch to prepare a magnetic tape.

### Example 6

With the exception that the polyurethane resin contained in the magnetic layer coating liquid was replaced with the polyurethane resin synthesized in Example 1, a magnetic tape was prepared by the same method as in Comparative Example 1.

### Example 7

With the exception that the quantity of curing agent (polyisocyanate) added to the dispersion during preparation of the magnetic layer coating liquid was changed to 5 parts, a magnetic tape was prepared by the same method as in Example 6.

### Example 8

With the exception that the polyurethane resin contained in the magnetic layer coating liquid was changed to the polyurethane resin synthesized in Example 3, a magnetic tape was prepared by the same method as in Example 7.

### Example 9

With the exception that the polyurethane contained in the magnetic layer coating liquid was changed to the polyurethane resin synthesized in Example 4, a magnetic tape was prepared by the same method as in Example 7.

### Example 10

With the exception that the polyurethane contained in the magnetic layer coating liquid was changed to the polyurethane resin synthesized in Example 5, a magnetic tape was prepared by the same method as in Example 7.

### 1. Magnetic Layer Surface Roughness

Measurement was conducted under the following conditions.

| Device: | Nanoscope III made by Nihon Veeco. |
|---|---|
| Mode: | Tapping mode |
| Measurement range: | 40 μm × 40 μm |
| Scan lines: | 512 * 512 |
| Scan speed: | 1.5 Hz |
| Scan direction: | Longitudinal direction of medium |
| (Correction) | |
| Flatten order: | 3 |
| X-axis: | 2 |

### 2. Head Grime

A tape sample was run 500 m by the “Running method” set forth below. Following running, the head was examined by an optical microscope and head grime was evaluated. The image of the head as observed by an optical microscope was inputted to a PC and rendered binary. A head (as observed at 50× magnification) with a tape sliding surface that exhibited grime over an area of equal to or more than 0 percent and equal to or less than 10 percent was evaluated as \textcircled{∘}, over an area exceeding 10 percent but equal to or less than 15 percent as ◯, and over an area exceeding 15 percent as X.

(Running Method)

Tape samples in the form of 800 m rolls were run at a running speed of 6 m/s, a back tension of 0.7 N, and a tape/head angle (½ the lap angle) of 10° while being wound/unwound reel to reel with a magnetic tape tester.

### 3. Evaluation of Coating Strength (Alumina Scratching)

To evaluate the coating strength, each tape was subjected to 20 scraping passes with alumina balls in an environment of 23° C. and 10 percent humidity with a load of 20 g. The scraped surface was examined under a microscope and the presence or absence of scratches was determined.

### 4. Tape Curing Property Test

Tape samples were extracted and gel component ratio measurement was conducted by the test method given below. The higher the tape gel component, the better the curing property, and the greater the durability of the tape.

(Test Method)

A 1 g quantity of magnetic tape was weighed out. The sample was hot extracted for 1.5 hours at 60° C. using tetrahydrofuran (THF) as solvent. The THF was concentrated to solid with an evaporator and the tape sol component ratio (extracted component) was measured by mass spectrometry. The gel component ratio (residual component) was calculated as 100—measured sol component ratio.

TABLE 1

| | Binder of | | | | | | |
|---|---|---|---|---|---|---|---|
| | magnetic layer | | | | | | |
| | Content | | Quantity | Surface | | | |
| | of | Content | of curing | roughness | | | |
| | sulfonic | of | agent in | of | | | |
| | acid salt | lactone | magnetic | magnetic | | | Tape gel |
| | group | ring | layer | layer | Head | Alumina | component |
| | (meq/g) | (meq/g) | (parts) | (nm) | grime | scratching | ratio |
| Comp. Ex. 1 | 0.33 | 0 | 2.5 | 2.2 | X | Sort of | 49.3% |
| | | | | | | scratching | |
| Ex. 6 | 0 | 0.33 | 2.5 | 1.9 | ◯ | No | 66.6% |
| | | | | | | scratching | |
| Ex. 7 | 0 | 0.33 | 5 | 2 | ⊚ | No | 70.0% |
| | | | | | | scratching | |
| Ex. 8 | 0 | 0.33 | 5 | 1.9 | ⊚ | No | 95.0% |
| | | | | | | scratching | |
| Ex. 9 | 0.4 | 0.33 | 5 | 1.85 | ⊚ | No | 95.0% |
| | | | | | | scratching | |
| Ex. 10 | 0.4 | 0.33 | 5 | 1.85 | ⊚ | No | 95.0% |
| | | | | | | scratching | |

### Evaluation Results

Based on the results of Table 1, it will be understood that the use of lactone ring-containing polyurethane resin as binder in the magnetic layer achieved both good surface smoothness and inhibited head grime. Examples 6 to 10 exhibited no alumina scratching and had good coating strength. Thus, it will be understood that lactone ring-containing polyurethane resin reacts well with trifunctional or greater polyisocyanate, thereby increasing the coating strength. Of these Examples, Examples 8 to 10, which employed polyurethane resins made from a starting material in the form of a diol in which R⁴ and R⁵ in general formula (IV) denoted ester groups, exhibited higher tape gel component ratios than Examples 6 and 7. This was attributed to the fact that, as set forth above, the polyurethane made from a starting material in the form of the diol denoted by general formula (IV) in which R⁴ and R⁵ denote ester groups can produce three hydroxyl groups which then cure and react with the polyisocyanate, increasing the coating strength.

### Example 11

### Application of Lactone Ring-Containing Polyurethane Resin to Nonmagnetic Coating Material

One weight part of the polyurethane resin synthesized in Example 2 was suspended in a solution comprised of 3.3 weight parts of the nonmagnetic powder indicated below, 11.9 weight parts of cyclohexanone, and 17.7 weight parts of 2-butanone. To the suspension were added 27 weight parts of zirconia beads (made by Nikkato Corporation) and the mixture was dispersed for 6 hours. The ratio of the presence of the dispersed polyurethane on the nonmagnetic powder surface/in the solution was measured at 9.0/1 by the method described below. The liquid obtained was applied to a PEN film made by Teijin (Ltd.) and dried to prepare a sheet. The gloss level of the sheet was measured at 180. The higher the gloss, the better the dispersibility of the nonmagnetic powder indicated. The gloss level was measured with a GK-45D made by Suga Test Instruments Co., Ltd.

Nonmagnetic Powder
α-iron oxide
Surface-treatment coating layer: Al₂O₃, SiO₂
Average major axis length: 0.15 μm
Average acicular ratio: 7
Specific surface area by BET method: 52 m²/g
pH: 8

### Method of Measuring the Ratio of the Presence of Polyurethane

Powder and solution were centrifugally separated under conditions of 100,000 rpm and 80 minutes in a small separation-use ultracentrifuge, the CS150GXL, made by Hitachi. A 3 mL quantity of the supernatant was weighed out for measurement. After being dried under conditions of 40° C. for 18 hours, the sample was dried under vacuum conditions at 140° C. for 3 hours. The weight of the dried sample was adopted as the solid component of unadsorbed binder and the ratio of the presence of the binder on the powder surface/in the solution was calculated.

### Comparative Example 2

### Application of Acyclic Polyester Polyurethane Resin to Nonmagnetic Coating Material

To 72.3 weight parts of cyclohexanone were added 35.8 weight parts of polyol (Adeka polyether BPX-1000 made by ADEKA Corporation) and 16.3 weight parts of tricyclo[5,2,1,0(2,6)]decanedimethanol (made by Tokyo Chemical Industry Co., Ltd.) and the mixture was fully dissolved by stirring for 30 minutes at room temperature. The moisture in the flask was measured with a Karl Fischer moisture meter, and diphenylmethane diisocyanate (Millionate MT made by Nippon Polyurethane Industry Co., Ltd.) was added in a molar quantity equal to that of the water content. The internal temperature was adjusted to 80° C., after which 55.0 weight parts of cyclohexanone containing 50 weight percent of diphenylmethane diisocyanate (Millionate MT made by Nippon Polyurethane Industry Co., Ltd.) were added dropwise at a rate resulting in an internal temperature of 80 to 90° C. The mixture was stirred for 4 hours at an internal temperature of 80 to 90° C. and then cooled to room temperature.

The weight average molecular weight and the ratio of the weight average molecular weight to the number average molecular weight (Mw/Mn) of the polyurethane obtained were calculated by standard polystyrene conversion using DMF solution containing 0.3 weight percent of lithium bromide. The weight average molecular weight was 70,000 and the Mw/Mn=1.90.

One weight part of the above polyurethane resin was suspended in a solution comprised of 3.3 weight parts of the same nonmagnetic powder as in Example 11, 11.9 weight parts of cyclohexanone, and 17.7 weight parts of 2-butanone. To the suspension were added 27 weight parts of zirconia beads (made by Nikkato Corporation) and the mixture was dispersed for 6 hours. The ratio of the presence of the dispersed polyurethane on the nonmagnetic powder surface/in the solution was measured at 0.8/1 by the method set forth above. The liquid obtained was applied to a PEN film made by Teijin (Ltd.) and dried to prepare a sheet. The gloss of the sheet was measured by the same method as in Example 11 at a gloss level of 0.

From the above results, it will be understood that the lactone-ring containing polyurethane resin employed in Example 11 exhibited high adsorption to the nonmagnetic powder surface. This was attributed to the fact that the lactone ring opened upon contact with the nonmagnetic powder surface, producing adsorption functional groups in the form of carboxyl groups. Since the gloss of the sheet prepared in Example 11 was higher than that of the sheet produced in Comparative Example 2, it will be understood that the lactone ring-containing polyurethane resin employed in Example 11 had the effect of increasing dispersion of the nonmagnetic powder.

### Example 12

### Synthesis of Lactone Ring-Containing Polyurethane Resin (6)

To 14.2 weight parts of cyclohexanone were added 1.0 weight part of D-erythronolactone, 28.3 weight parts of polyether (Adeka polyether BPX-1000, made by ADEKA Corporation), 12.9 weight parts of tricyclo[5,2,1,0(2,6)]decanedimethanol (made by Tokyo Chemical Industry Co., Ltd.), 0.9 weight part of lithium N,N-bis(hydroxyalkyl)aminoethylsulfonate, and 0.01 weight part of dibutyltin dilaurate and the mixture was fully dissolved by stirring for 30 minutes at room temperature. The moisture in the flask was measured with a Karl Fischer moisture meter, and diphenylmethane diisocyanate (Millionate MT made by Nippon Polyurethane Industry Co., Ltd.) was added in a molar quantity equal to that of the water content. The internal temperature was adjusted to 80° C., after which 17.8 weight parts of cyclohexanone containing 50 weight percent of diphenylmethane diisocyanate (Millionate MT made by Nippon Polyurethane Industry Co., Ltd.) were added dropwise at a rate resulting in an internal temperature of 80 to 90° C. The mixture was stirred for 4 hours at an internal temperature of 80 to 90° C. and then cooled to room temperature.

The weight average molecular weight and the ratio of the weight average molecular weight to the number average molecular weight (Mw/Mn) of the polyurethane obtained were calculated by standard polystyrene conversion using DMF solution containing 0.3 weight percent of lithium bromide. The weight average molecular weight was 70,000 and the Mw/Mn=1.90.

### Example 13

### Synthesis of Lactone Ring-Containing Polyurethane Resin (7)

To 277.6 weight parts of cyclohexanone were added 1.0 weight part of D-erythronolactone, 51.5 weight parts of polyether (Adeka polyether BPX-1000, made by ADEKA Corporation), 36.0 weight parts of tricyclo[5,2,1,0(2,6)]decanedimethanol (made by Tokyo Chemical Industry Co., Ltd.), 1.4 weight part of carboxylic acid salt group-containing diol (N,N-di(2-hydroxyethyl)glycine (made by Tokyo Chemical Industry Co., Ltd.)), and 0.01 weight part of dibutyltin dilaurate and the mixture was fully dissolved by stirring for 30 minutes at room temperature. The moisture in the flask was measured with a Karl Fischer moisture meter, and diphenylmethane diisocyanate (Millionate MT made by Nippon Polyurethane Industry Co., Ltd.) was added in a molar quantity equal to that of the water content. The internal temperature was adjusted to 80° C., after which 102.4 weight parts of cyclohexanone containing 50 weight percent of diphenylmethane diisocyanate (Millionate MT made by Nippon Polyurethane Industry Co., Ltd.) were added dropwise at a rate resulting in an internal temperature of 80 to 90° C. The mixture was stirred for 4 hours at an internal temperature of 80 to 90° C. and then cooled to room temperature.

The weight average molecular weight and the ratio of the weight average molecular weight to the number average molecular weight (Mw/Mn) of the polyurethane obtained were calculated by standard polystyrene conversion using DMF solution containing 0.3 weight percent of lithium bromide. The weight average molecular weight was 70,000 and the Mw/Mn=1.90.

### Example 14

### Application of Lactone Ring-Containing Polyurethane Resin to Barium Ferrite-Containing Magnetic Coating Material

One weight part of polyurethane resin synthesized in Example 12 was suspended in a solution comprised of 3.3 weight parts of the hexagonal barium ferrite employed in Examples 6 to 10, 11.9 weight parts of cyclohexanone, and 17.7 weight parts of 2-butanone. To the suspension were added 27 weight parts of zirconia beads (made by Nikkato Corporation) and the mixture was dispersed for 6 hours. The ratio of the presence of the dispersed polyurethane on the magnetic powder surface/in the solution was measured at 9.0/1 by the method set forth above. The liquid obtained was applied to a PEN film made by Teijin (Ltd.) and dried to prepare a sheet. The gloss level of the sheet was measured at 160. The higher the gloss, the better the dispersibility of the magnetic powder indicated. The gloss level was measured with a GK-45D made by Suga Test Instruments Co., Ltd.

### Example 15

### Application of Lactone Ring-Containing Polyurethane Resin to Barium Ferrite-Containing Magnetic Coating Material

The polyurethane resin synthesized in Example 12 was replaced with the polyurethane resin synthesized in Example 3. When the same evaluation as in Example 14 was conducted, the ratio of the presence of dispersed polyurethane on the magnetic powder surface/in the solution was 9.0/1 and the gloss of the sheet was 181.

### Example 16

With the exception that the polyurethane resin synthesized in Example 12 was replaced with the polyurethane resin synthesized in Example 4, a sheet was prepared by the same method as in Example 14. Gloss evaluation revealed a sheet gloss of 191.

### Example 17

With the exception that the polyurethane resin synthesized in Example 12 was replaced with the polyurethane resin synthesized in Example 5, a sheet was prepared by the same method as in Example 14. Gloss evaluation revealed a sheet gloss of 190.

### Example 18

### Application of Lactone Ring-Containing Polyurethane Resin to Barium Ferrite-Containing Magnetic Coating Material

With the exception that the polyurethane resin synthesized in Example 12 was replaced with the polyurethane resin synthesized in Example 13, a sheet was prepared by the same method as in Example 14. Gloss evaluation revealed a sheet gloss of 178.

### Comparative Example 3

### Application of Acyclic Polyester Polyurethane Resin to Barium Ferrite-Containing Magnetic Coating Material

One weight part of polyurethane resin synthesized in Comparative Example 2 was suspended in a solution comprised of 3.3 weight parts of the hexagonal barium ferrite employed in Examples 6 to 10, 11.9 weight parts of cyclohexanone, and 17.7 weight parts of 2-butanone. To the suspension were added 27 weight parts of zirconia beads (made by Nikkato Corporation) and the mixture was dispersed for 6 hours. The ratio of the presence of the dispersed polyurethane on the magnetic powder surface/in the solution was measured at 1.0/9.0 by the method set forth above. The liquid obtained was applied to a PEN film made by Teijin (Ltd.) and dried to prepare a sheet. The gloss of the sheet as measured by the same method as in Example 14 was 0.

From the results of the ratio of the presence of polyurethane on the magnetic powder surface/in the solution in Example 14 and 15, it will be understood that the lactone ring-containing polyurethane resins employed in these Examples exhibited high adsorption to the magnetic powder surface. This was attributed to the fact that the lactone ring opened upon contact with the magnetic powder surface, producing adsorption functional groups in the form of carboxyl groups. Since the gloss of the sheets prepared in Examples 14 to 18 was higher than that of the sheet produced in Comparative Example 3, it will be understood that the lactone ring-containing polyurethane resin employed in Examples 14 to 18 had the effect of increasing dispersion of the magnetic powder.

According to the present invention, magnetic recording media with high surface smoothness that is suited to high-density recording can be provided.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

What is claimed is:

1. A magnetic recording medium comprising a magnetic layer comprising a ferromagnetic power and a binder on a nonmagnetic support, wherein,
the binder comprises a constituent component in the form of a polyurethane resin obtained from starting materials in the form of a polyisocyanate and a polyol denoted by general formula (I): 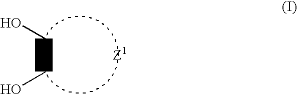
wherein, in general formula (I), Z¹ denotes an atom group forming a lactone ring with two adjacent carbon atoms.

2. The magnetic recording medium according to claim 1, wherein the polyol denoted by general formula (I) comprises a polyol denoted by general formula (II) and/or a polyol denoted by general formula (III): 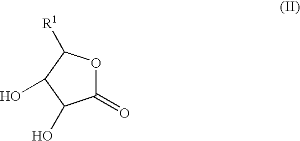
wherein, in general formula (II), R¹ denotes a hydrogen atom, hydroxyl group, or alkyl group; 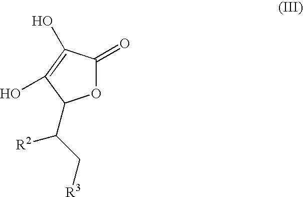
wherein, in general formula (III), each of R² and R³ independently denotes an alkoxyl group or an ester group.

3. The magnetic recording medium according to claim 2, wherein the polyol denoted by general formula (III) comprises a polyol denoted by general formula (IV): 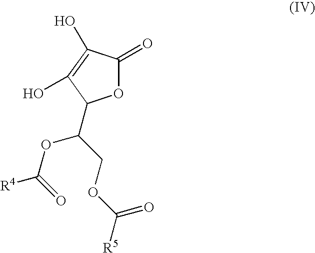
wherein, in general formula (IV), each of R⁴ and R⁵ independently denotes an alkyl group, aryl group, or heteroaryl group, and R⁴ and R⁵ may bond together to form a ring structure.

4. The magnetic recording medium according to claim 1, wherein the binder comprises a reaction product of the polyurethane resin and a trifunctional or greater polyisocyanate.

5. The magnetic recording medium according to claim 1, wherein the polyurethane resin comprises a sulfonic acid (salt) group in a quantity of 10 to 1,000 μeq/g.

6. A magnetic recording medium comprising a nonmagnetic layer comprising a nonmagnetic powder and a binder and a magnetic layer comprising a magnetic layer and a binder in this order on a nonmagnetic support, wherein
the binder comprised in the magnetic layer and/or the binder comprised in the nonmagnetic layer comprise a constituent component in the form of a polyurethane resin obtained from starting materials in the form of a polyisocyanate and a polyol denoted by general formula (I): 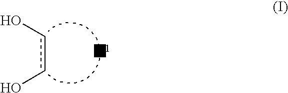
wherein, in general formula (I), Z¹ denotes an atom group forming a lactone ring with two adjacent carbon atoms.

7. The magnetic recording medium according to claim 6, wherein the polyol denoted by general formula (I) comprises a polyol denoted by general formula (II) and/or a polyol denoted by general formula (III): 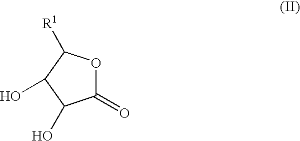
wherein, in general formula (II), R¹ denotes a hydrogen atom, hydroxyl group, or alkyl group; 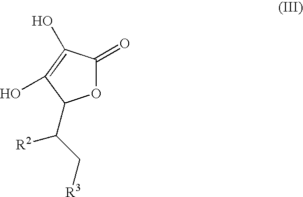
wherein, in general formula (III), each of R² and R³ independently denotes an alkoxyl group or an ester group.

8. The magnetic recording medium according to claim 7, wherein the polyol denoted by general formula (III) comprises a polyol denoted by general formula (IV): 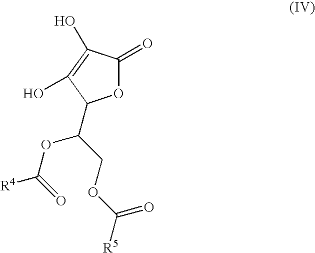
wherein, in general formula (IV), each of R⁴ and R⁵ independently denotes an alkyl group, aryl group, or heteroaryl group, and R⁴ and R⁵ may bond together to form a ring structure.

9. The magnetic recording medium according to claim 6, wherein the binder comprises a reaction product of the polyurethane resin and a trifunctional or greater polyisocyanate.

10. The magnetic recording medium according to claim 6, wherein the polyurethane resin comprises a sulfonic acid (salt) group in a quantity of 10 to 1,000 μeq/g.

11. A binder for a magnetic recording medium, comprising a constituent component in the form of a polyurethane resin obtained from starting materials in the form of a polyisocyanate and a polyol denoted by general formula (I): 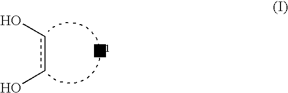
wherein, in general formula (I), Z¹ denotes an atom group forming a lactone ring with two adjacent carbon atoms.

12. The binder according to claim 11, wherein the polyol denoted by general formula (I) comprises a polyol denoted by general formula (II) and/or a polyol denoted by general formula (III): 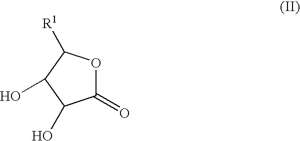
wherein, in general formula (II), R¹ denotes a hydrogen atom, hydroxyl group, or alkyl group; 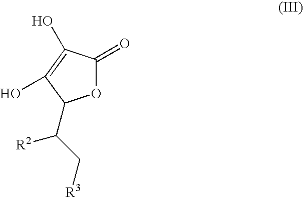
wherein, in general formula (III), each of R² and R³ independently denotes an alkoxyl group or an ester group.

13. The binder according to claim 12, wherein the polyol denoted by general formula (III) comprises a polyol denoted by general formula (IV): 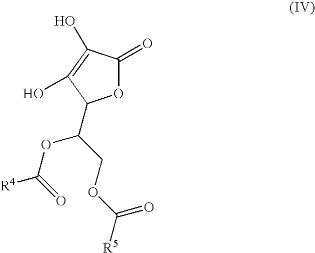
wherein, in general formula (IV), each of R⁴ and R⁵ independently denotes an alkyl group, aryl group, or heteroaryl group, and R⁴ and R⁵ may bond together to form a ring structure.

14. The binder according to claim 11, comprising a reaction product of the polyurethane resin and a trifunctional or greater polyisocyanate.

15. The binder according to claim 11, wherein the polyurethane resin comprises a sulfonic acid (salt) group in a quantity of 10 to 1,000 μeq/g.

16. The binder according to claim 11, which is a binder for a nonmagnetic layer and/or a magnetic layer of a magnetic recording medium.

17. A polyurethane resin, obtained from starting materials in the form of a polyisocyanate and a polyol denoted by general formula (I): 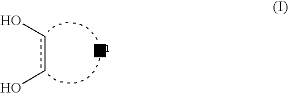
wherein, in general formula (I), Z¹ denotes an atom group forming a lactone ring with two adjacent carbon atoms.

18. The polyurethane resin according to claim 17, wherein the polyol denoted by general formula (I) comprises a polyol denoted by general formula (II) and/or a polyol denoted by general formula (III): 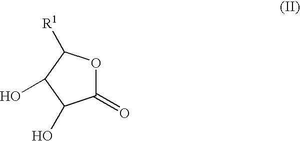
wherein, in general formula (II), R¹ denotes a hydrogen atom, hydroxyl group, or alkyl group; 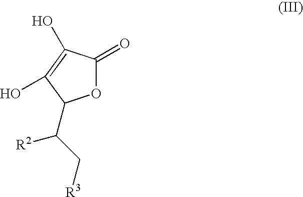
wherein, in general formula (III), each of R² and R³ independently denotes an alkoxyl group or an ester group.

19. The polyurethane resin according to claim 18, wherein the polyol denoted by general formula (III) comprises a polyol denoted by general formula (IV): 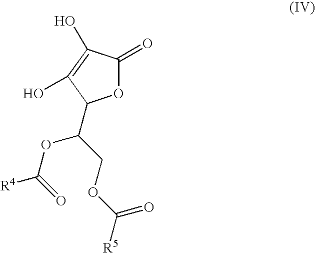
wherein, in general formula (IV), each of R⁴ and R⁵ independently denotes an alkyl group, aryl group, or heteroaryl group, and R⁴ and R⁵ may bond together to form a ring structure.

20. The polyurethane resin according to claim 17, comprising a sulfonic acid (salt) group in a quantity of 10 to 1,000 μeq/g.
